(19) United States
(12) Patent Application Publication
(10) Pub. No.: US 2014/0157382 A1
(43) Pub. Date: Jun. 5, 2014

(54) OBSERVABLE AUTHENTICATION METHODS AND APPARATUS

(71) Applicant: SUNSTONE INFORMATION DEFENSE, INC., Carmel, CA (US)

(72) Inventor: David K. Ford, Carmel, CA (US)

(73) Assignee: SunStone Information Defense, Inc., Carmel, CA (US)

(21) Appl. No.: 13/837,767

(22) Filed: Mar. 15, 2013

Related U.S. Application Data
(60) Provisional application No. 61/732,004, filed on Nov. 30, 2012.

(51) Int. Cl. H04L 29/06

(52) U.S. Cl. CPC H04L 63/08
USPC 726/7

(57) ABSTRACT

A system, method, and apparatus for providing observable authentication are disclosed. An example method includes receiving a request from a user to access an account, the request including an identifier associated with the user, determining a secret login rule previously provided to the user, and transmitting observable information to be displayed in a login map by a client device associated with the user. The example method also includes determining a correct answer by analyzing the positioning of the displayed observable information within the login map in conjunction with the secret login rule associated with the user. The example method further includes receiving an answer from the client device and providing the user access to the account responsive to the answer matching the correct answer.

### PRIORITY CLAIM

The present application claims priority to and the benefit of U.S. Provisional Patent Application No. 61/732,004, filed on Nov. 30, 2012, the entirety of which is incorporated herein by reference.

### BACKGROUND

Account access is a significant security concern for many service, application, and account providers. FIG. 1 shows a typical user login interface 100 where a user types a username and a corresponding password. Malicious applications (e.g., computer viruses, counterfeit hardware components, unauthorized third parties, computer worms, Trojan horses, rootkits, spyware, adware, etc.) are increasingly becoming sophisticated at detecting a user's account login username and password. In many instances the fields in the webpage are labeled as ‘username’ and ‘password.’ In some detection examples, some malicious applications detect and decipher Internet Protocol packets that include a user's account login information (e.g., codeword sets). In other detection examples, malicious applications may operate undetected in the background of a user's device to acquire the user's login information using, for example, a keystroke logger.

To combat these malicious applications, account security providers have attempted to replace or move keyboard functionality from a user's device to a server or processor of the service/account provider. For instance, FIGS. 2 and 3 show user interfaces 200 and 300 that include virtual keyboards. To enter account login information, a user selects portions of the user interfaces 200 and 300 that correspond to keyboard keys. As a result, coordinates of the user interfaces 200 and 300 are transmitted to a service/account provider instead of a user's login information.

As can be expected, malicious applications have counteracted these security measures by capturing screenshots of the user interfaces 200 and 300 as a user is entering information. For instance, a malicious application monitors user interface 300 and records a mouse cursor over the letters ‘M,’ ‘Y,’ and ‘P.’ The malicious application transmits the screenshots to a third party or processor to determine the username and password of the user. The malicious third party uses image processing to determine the content of the recorded visual/graphical information. The malicious third party may then replay the visual information to gain access to the user's account. As a result, security for this type of virtual keyboard is only effective until the login process is observed by a malicious application.

Other service/account providers use visual login routines that attempt to avoid having a user enter the same password. For example, FIG. 4 shows a user interface 400 of a visual authentication process. The user interface 400 includes a picture 402 and a security question 404 associated with the picture. The identity of the image in the picture 402 corresponds to an answer that is known to the user. The user may not have previously entered the identity of the person in the picture 402. For example, the service/account provider may search through a user's account to locate the picture 402 among an album of pictures and the corresponding identity of a person in the picture tagged by the user.

In the example shown in FIG. 4, the user provides the answer to the question 404 in the text field 406. However, a malicious application that is monitoring the user interface 400 detects the picture and answer. The malicious application stores a copy of the picture 402 and answer provided in text field 406 to later access the user's account. As a result, the visual login routine shown in FIG. 4 has already been compromised after one use. There is accordingly a need to provide secure account login that is not observable by malicious applications.

### SUMMARY

The present disclosure provides a new and innovative system, method, and apparatus for providing observable authentication. A security processor provides observable authentication by separately providing users unique secret login rules, which specify how randomly generated information (e.g., a login map) is to be interpreted by a user. Each user uses their interpretation, as specified by their unique secret login rule(s), to provide an answer to the randomly generated information. The security processor, which also stories a copy of the user's secret login rule(s), provides the user access to an account if the user's answer matches the answer determined by the security processor. In this manner, only information (i.e., the randomly generated information of the login map or the user's answer) is transmitted between users and the security processor. The secret login rules are separately know by the users and the security processor but are not transmitted during an account transaction. This separation of the secret login rules prevents malicious applications from being able to determine how to improperly access user accounts.

In an example method, a security processor receives a request from a user to access an account, the request including an identifier associated with the user. The security processor determines a secret login rule previously provided to the user and transmits observable information to be displayed in a login map by a client device associated with the user. The security processor also determines a correct answer by analyzing the positioning of the displayed observable information within the login map and the secret login rule associated with the user. The security processor further receives an answer from the client device and provides the user access to the account responsive to the answer matching the correct answer.

Additional features and advantages of the disclosed system, method, and apparatus are described in, and will be apparent from, the following Detailed Description and the Figures.

### BRIEF DESCRIPTION OF THE FIGURES

FIGS. 1 to 4 are diagrams of prior art user interfaces that include prompts for user account login information.

FIG. 5 is a block diagram of an example network communication system, according to an example embodiment of the present invention.

FIG. 6 is a detailed block diagram showing an example of a client device, application server, or database server according to an example embodiment of the present invention.

FIGS. 7 to 10 show diagrams of a client device displaying observable authentication using a character grid or array login map, according to an example embodiment of the present invention.

FIG. 11 shows a diagram of a rotary login map example embodiment.

FIGS. 12 to 14 show diagrams of a dot-matrix grid login map example embodiment.

FIG. 15 shows a diagram of a data structure that is used by an example security processor of FIGS. 5 and 6 to store secret login rules for different users.

FIGS. 16 and 17 illustrate flow diagrams showing example procedures to provide observable authentication, according to an example embodiment of the present invention.

FIGS. 18 and 19 show diagrams of a crypto-grid login map example embodiment.

FIG. 20 shows a diagram of a combination login map example embodiment.

FIGS. 21 and 22 show diagrams of example character grid login map embodiments.

FIGS. 23 to 25 show diagrams of a scan pattern character grid embodiment.

FIG. 26 shows a diagram of a hardware embodiment that uses electronically coded versions of login maps and secret login rules.

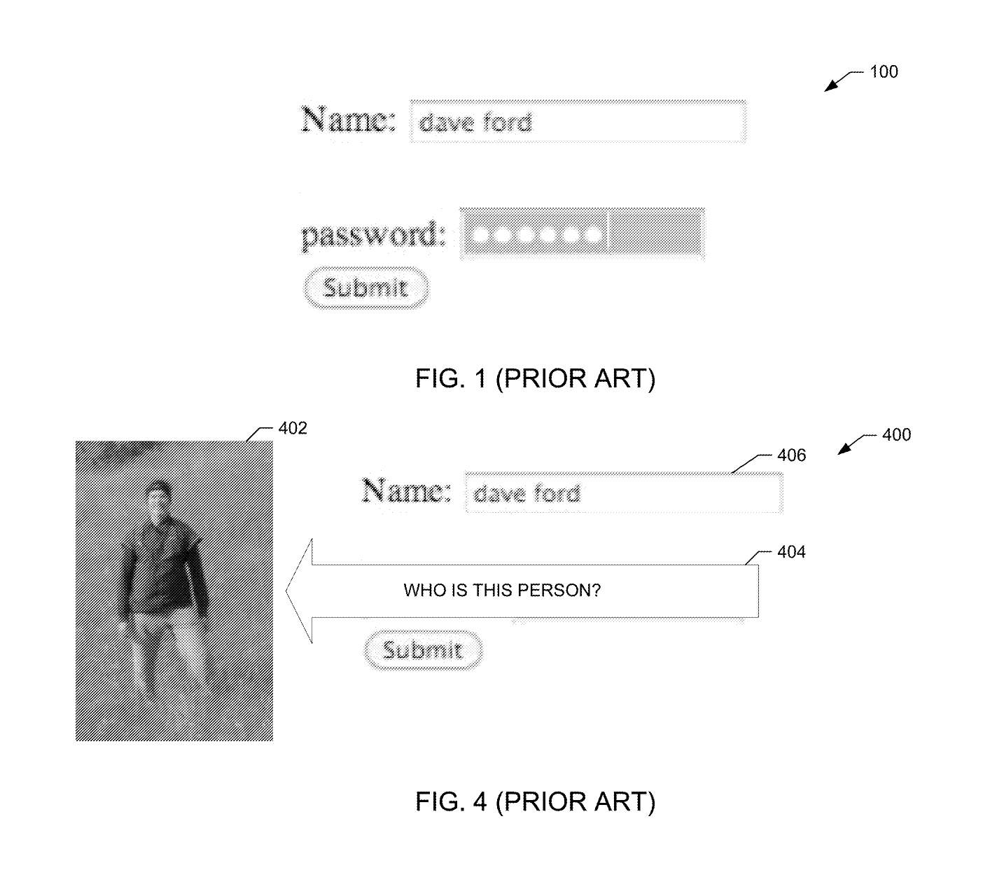

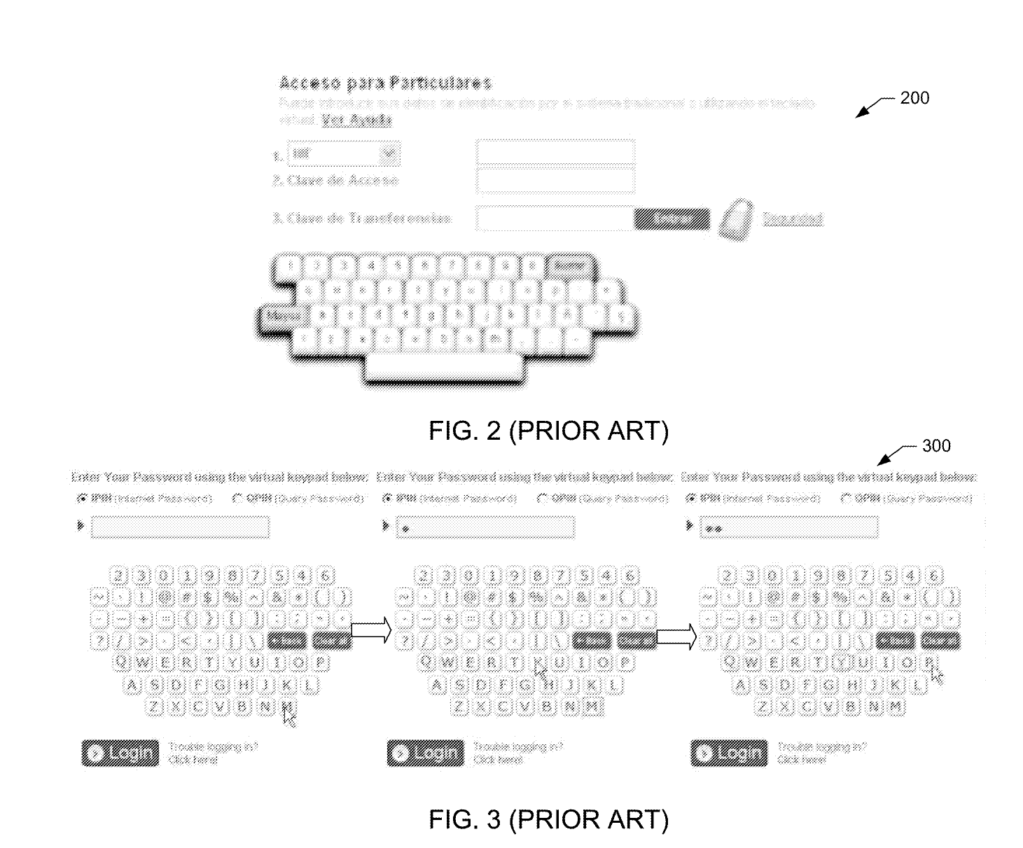

### DETAILED DESCRIPTION

The present disclosure relates in general to a method, apparatus, and system to provide observable authentication and, in particular, to providing an account authentication mechanism that is observable to the users while at the same time being unobservable to malicious applications.

Briefly, in an example embodiment, a system is provided that manages user authentication for accounts by providing login maps to users. The example system pre-assigns each user one or more secret login rules corresponding to the type of login map. The example system provides access to an account if a user is able to provide a correct answer to a login map based on the secret login rules assigned to the user. In some embodiments, the complexity of the secret login rules is selected by a user.

As discussed herein, a login map is a diagram or structured graphical representation of characters (or symbols, markings, etc.) arranged in a pattern. The login map includes observable information comprising, for example, an array of characters, characters arranged in circular patterns, etc. The example system disclosed herein is described in conjunction with only a few different types of login maps. It should be appreciated that the disclosed system is capable of performing observable authentication for any type of login map with properties similar to those discussed.

A common trait among login maps is that they provide (randomly generated) observable information that is useful to a user to access an account while at the same time providing information that is not useful to a malicious application. The user uses one or more pre-assigned secret login rules to identify which of the provided observable information is useful. As a result, a malicious application that is observing a display of a client device used by the user is unable to differentiate between useful and useless information. The example system disclosed herein thereby provides account security that cannot be overcome by malicious applications monitoring client devices of users.

Throughout the disclosure, reference is made to malicious applications (e.g., malware), which can include any computer virus, keylogger, mouse-logger, finger-logger, remote desktop connection, bogus password reset website, counterfeit hardware component, unauthorized third party access, computer worm, Trojan horse, rootkit, spyware, adware, or any other malicious or unwanted software that attempts to obtain user account login information. Malicious applications can interfere with communications of a live session between a server and a client device. Alternatively, malicious applications may record account information and later access a user's account.

Additionally, throughout the disclosure, reference is made to client devices, which can include any cellphone, smartphone, personal digital assistant (“PDA”), mobile device, tablet computer, computer, laptop, server, processor, console, gaming system, multimedia receiver, or any other computing device. While this disclosure refers to connection between a single client device and a server, the example method, apparatus, and system disclosed herein can be applied to multiple client devices connected to one or more servers.

Examples in this disclosure describe client devices and servers performing account access transactions (e.g., banking transactions). However, the example method, apparatus, and system disclosed herein can be applied to any type of transaction or controlled usage of resources between a server and a client device including, but not limited to, online purchases of goods or services, point of sale purchases of goods or services, medical applications/networks (e.g., remotely accessing a medical device or network), manufacturing processes (e.g., remote manufacturing monitoring and control), infrastructure components (e.g., monitoring and control of the flow of electricity, oil, or flow of information in data networks), social network access, or access of other sensitive and confidential information.

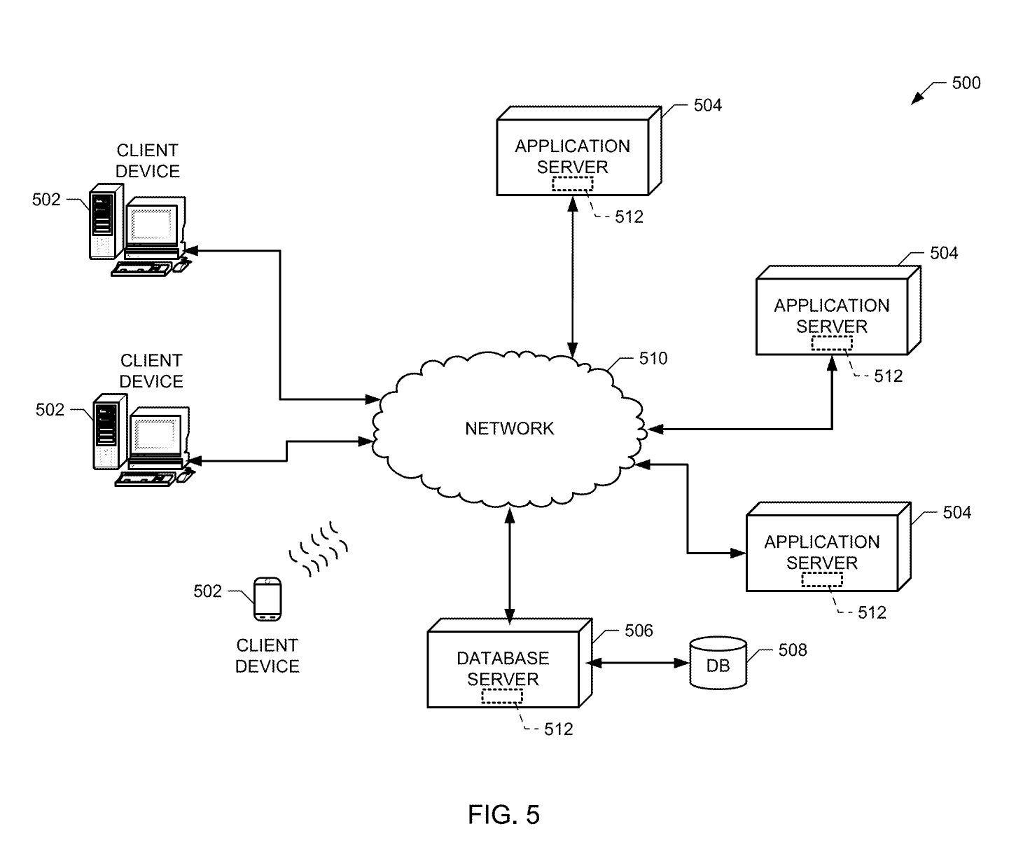

The present system may be readily realized in a network communications system. A high level block diagram of an example network communications system 500 is illustrated in FIG. 5. The illustrated system 500 includes one or more client devices 502, one or more application servers 504, and one or more database servers 506 connected to one or more databases 508. Each of these devices may communicate with each other via a connection to one or more communication channels in a network 510. The network 510 can include, for example the Internet or some other data network, including, but not limited to, any suitable wide area network or local area network. It should be appreciated that any of the devices described herein may be directly connected to each other and/or connected through the network 510. The network 510 may also support wireless communication with wireless client devices 502.

The client devices 502 access data, services, media content, and any other type of information located on the servers 504 and 506. The client devices 502 may include any type of operating system and perform any function capable of being performed by a processor. For instance, the client devices 502 may access, read, and/or write information corresponding to services or applications hosted by the servers 504 and 506.

Typically, servers 504 and 506 process one or more of a plurality of files, programs, data structures, databases, and/or web pages in one or more memories for use by the client devices 502, and/or other servers 504 and 506. The application servers 504 provide services accessible to the client devices 502 while the database servers 506 provide a framework for the client devices 502 to access data stored in the database 508. The servers 504 and 506 may be configured according to their particular operating system, applications, memory, hardware, etc., and may provide various options for managing the execution of the programs and applications, as well as various administrative tasks. A server 504, 506 may interact via one or more networks with one or more other servers 504 and 506, which may be operated independently.

The example servers 504 and 506 provide data and services to the client devices 502. The servers 504 and 506 may be managed by one or more service providers, which control the information and types of services offered. These services providers also determine qualifications as to which client devices 502 are authorized to access the servers 504 and 506. The servers 504 and 506 can provide, for example, banking services, online retain services, social media content, multimedia services, government services, educational services, etc.

Additionally, the servers 504 and 506 provide authentication to control processes within a facility, such as a process control system. In these instances, the servers 504 and 506 provide the client devices 502 access to read, write, or subscribe to data and information associated with specific processes. For example, the application servers 504 may provide information and control to the client devices 502 for an oil refinery or a manufacturing plant. In this example, a user of the client device 502 can access an application server 504 to view statuses of equipment within the plant or to set controls for the equipment within the plant.

While the servers 504 and 506 are shown as individual entities, each server 504 and 504 may be partitioned or distributed within a network. For instance, each server 504 and 506 may be implemented within a cloud computing network with different processes and data stored at different servers or processors. Additionally, multiple servers or processors located at different geographic locations may be grouped together as a server 504 and 506. In this instance, network routers determine which client device 502 connects to which processor within the application server 104.

In the illustrated example of FIG. 5, each of the servers 504 and 506 includes a security processor 512. The security processor 512 provides observable authentication to the client devices 102 by generating observable information within one or more login maps. The security processor 512 manages user authentication to provide access to client devices 102 that provide correct security information. The security processor 512 enables the client devices 102 to assess services, data, and/or applications hosted at the servers 504 and 506.

As disclosed herein, the security processor 512 provides observable authentication for users of client devices 502 by requiring users to register for an account. The registration includes a user providing a username and password. The registration may also include a user selecting a level of security desired to access the account. For example, a senior citizen may request a moderately secure level of security that requires less memorization.

Responsive to the information provided by users, the security processor 512 provides each user with unique secret login rule(s). The secret login rules are information provided to a user that specifies how observable information in a login map is to be processed, calculated, observed by a user for that user to receive access to an account. The secret login rules are selected based on the type of login map. For instance, a login map that includes different rows of character arrays corresponds to secret login rules that identify particular character locations in the array. A user may be granted access to an account if the user correctly identifies which of the rows includes letters from the user's password that are included within the particular locations of the arrays. In another embodiment, a login map that includes characters arranged in a circular shape includes login rules that specify a starting position among the characters, a finishing position among the characters, and a calculation the user is to perform to provide an answer to as the security answer.

In some examples the security processor 512 can provide a user with training as to how to apply secret login rules to a login map. For instance, the security processor 512 guides a user through a demo (or live) authentication after a user has created an account. The security processor 512 may first ask the user if the user would like a guided demonstration. If the user selects yes, the security processor 512 displays a login map in conjunction with visible cues (or audible cues) that correspond to the secret login rules. The visible cues include, for example, shading, highlights, arrows, text-based pop-ups, etc. that indicate to a user which portions of the login map are of concern based on the secret login rules. The security processor 512 may provide guided demonstrations for as long as a user requests or for a predetermined number of initial logins.

The security processor 512 also provides users an opportunity to change secret login rules. In some embodiments, a user may request new secret login rules by assessing an account page or form and specifying (e.g., drawing shapes over portions of bank login maps, designating portions of login maps, designated characters, specifying calculations to be performed, etc.). In other embodiments, the security processor 512 may use current secret login rules to communicate to the user the new secret login rules. For instance, the security processor 512 can provide four shaded dots in a first designated box and two shaded dots in a second designated box. A user uses the number of shaded dotes to determine the location of the designated boxes for the new secret login rules.

It can be appreciated that each different application server 504 uses a different type of login map. As a result, the corresponding security processor 512 applies secret login rules appropriate for the login map. However, in some embodiments, all the application servers 504 may use the same type of login map.

While each server 504 and 506 is shown as including a security processor 512, in other embodiments the security processor 512 may be remotely located from the servers 504 and 506 (e.g., the security processor 512 may be cloud-based). In these embodiments, the security processor 512 is communicatively coupled to the servers 504 and 506 and remotely provides observable authentication. For instance, the security processor 512 may provide login maps to the servers 504 and 506. The security processor 512 may also receive client device response messages from the servers 504 and 506. In instances when the security processor 512 detects a an incorrect answer to a login map, the security processor 512 remotely instructs the servers 504 and 506 how to remedy the situation.

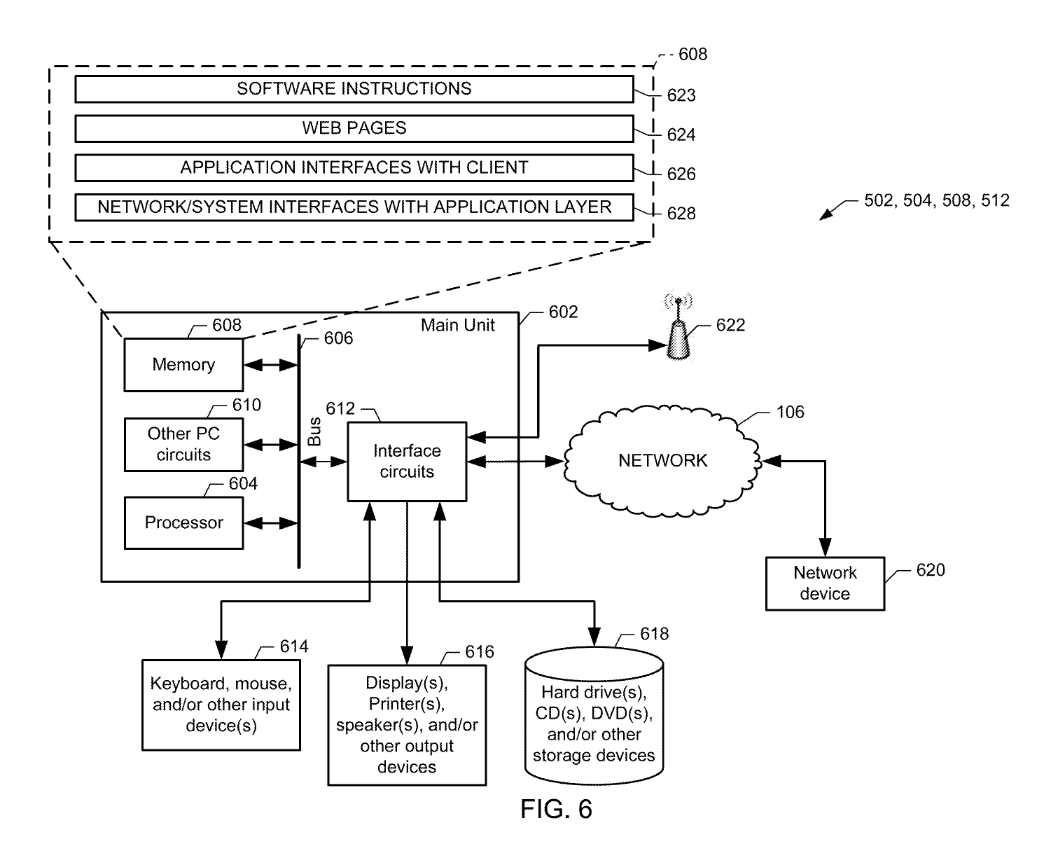

A detailed block diagram of electrical systems of an example computing device (e.g., a client device 502, an application server 504, a database server 506, or security processor 512) is illustrated in FIG. 6. In this example, the computing device 502, 504, 506, 512 includes a main unit 602 which preferably includes one or more processors 604 communicatively coupled by an address/data bus 606 to one or more memory devices 608, other computer circuitry 610, and one or more interface circuits 612. The processor 604 may be any suitable processor, such as a microprocessor from the INTEL PENTIUM® or CORE™ family of microprocessors. The memory 608 preferably includes volatile memory and non-volatile memory. Preferably, the memory 608 stores a software program that interacts with the other devices in the system 100, as described below. This program may be executed by the processor 604 in any suitable manner. In an example embodiment, memory 608 may be part of a “cloud” such that cloud computing may be utilized by computing devices 502, 504, 506, 512. The memory 608 may also store digital data indicative of documents, files, programs, web pages, etc. retrieved from computing device 502, 504, 506, 512 and/or loaded via an input device 514.

The example memory devices 608 store software instructions 623, webpages 624, user interface features, permissions, protocols, login maps, secret login rules, and/or configurations. The memory devices 608 also may store network or system interface features, permissions, protocols, configuration, and/or preference information 628 for use by the computing devices 502, 504, 506, 512. It will be appreciated that many other data fields and records may be stored in the memory device 608 to facilitate implementation of the methods and apparatus disclosed herein. In addition, it will be appreciated that any type of suitable data structure (e.g., a flat file data structure, a relational database, a tree data structure, etc.) may be used to facilitate implementation of the methods and apparatus disclosed herein.

The interface circuit 612 may be implemented using any suitable interface standard, such as an Ethernet interface and/or a Universal Serial Bus (USB) interface. One or more input devices 614 may be connected to the interface circuit 612 for entering data and commands into the main unit 602. For example, the input device 614 may be a keyboard, mouse, touch screen, track pad, track ball, isopoint, image sensor, character recognition, barcode scanner, microphone, and/or a speech or voice recognition system.

One or more displays, printers, speakers, and/or other output devices 616 may also be connected to the main unit 602 via the interface circuit 612. The display may be a cathode ray tube (CRTs), a liquid crystal display (LCD), or any other type of display. The display generates visual displays generated during operation of the computing device 502, 504, 506, 512. For example, the display may provide a user interface and may display one or more webpages received from a computing device 502, 504, 506, 512. A user interface may include prompts for human input from a user of a client device 502 including links, buttons, tabs, checkboxes, thumbnails, text fields, drop down boxes, etc., and may provide various outputs in response to the user inputs, such as text, still images, videos, audio, and animations.

One or more storage devices 608 may also be connected to the main unit 602 via the interface circuit 612. For example, a hard drive, CD drive, DVD drive, and/or other storage devices may be connected to the main unit 602. The storage devices 618 may store any type of data, such as pricing data, transaction data, operations data, inventory data, commission data, manufacturing data, marketing data, distribution data, consumer data, mapping data, image data, video data, audio data, tagging data, historical access or usage data, statistical data, security data, etc., which may be used by the computing device 502, 504, 506, 512.

The computing device 502, 504, 506, 512 may also exchange data with other network devices 620 via a connection to the network 510 or a wireless transceiver 622 connected to the network 510. Network devices 620 may include one or more servers (e.g., the application servers 504 or the database servers 506), which may be used to store certain types of data, and particularly large volumes of data which may be stored in one or more data repository. A server may include any kind of data including databases, programs, files, libraries, pricing data, transaction data, operations data, inventory data, commission data, manufacturing data, marketing data, distribution data, consumer data, mapping data, configuration data, index or tagging data, historical access or usage data, statistical data, security data, etc. A server may store and operate various applications relating to receiving, transmitting, processing, and storing the large volumes of data. It should be appreciated that various configurations of one or more servers may be used to support and maintain the system 500. For example, servers may be operated by various different entities, including sellers, retailers, manufacturers, distributors, service providers, marketers, information services, etc. Also, certain data may be stored in a client device 502 which is also stored on a server, either temporarily or permanently, for example in memory 608 or storage device 618. The network connection may be any type of network connection, such as an Ethernet connection, digital subscriber line (DSL), telephone line, coaxial cable, wireless connection, etc.

Access to a computing device 502, 504, 506, 512 can be controlled by appropriate security software or security measures. An individual users' access can be defined by the computing device 502, 504, 506, 512 and limited to certain data and/or actions. Accordingly, users of the system 100 may be required to register with one or more computing devices 502, 504, 506, 512 as described herein.

### Character Grid Embodiment

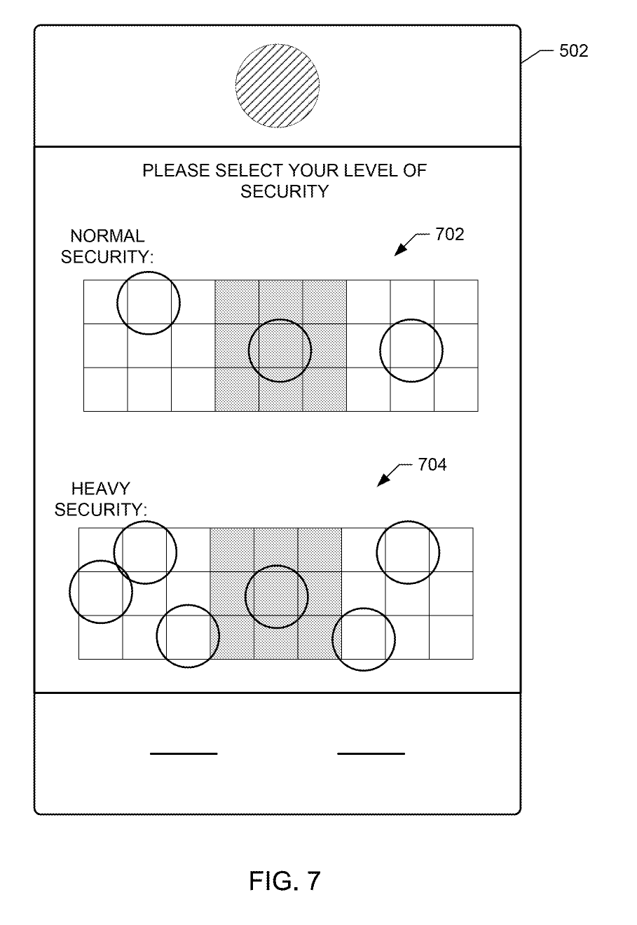

FIGS. 7 to 10 show diagrams of client device 502 displaying observable authentication using a character grid or array login map. It will be appreciated that other types of symbols, other than characters, may also be employed. FIG. 7 shows client device 502 displaying account configuration information to establish an account with an application server 504. A security processor 512 provides the account configuration information based on the type of login map used by the application server 504.

In this embodiment, the security processor 512 enables a user to select between two different levels of security for corresponding secret login rules. For instance, the normal security option includes three distinct boxes within array 702 and the greater security option includes six distinct boxes within array 704. The number of boxes and locations within the arrays 702 and 704 is only representative of the secret login rules. The security processor 512 may change which boxes within the selected array 702, 704 are identified in the secret login rules.

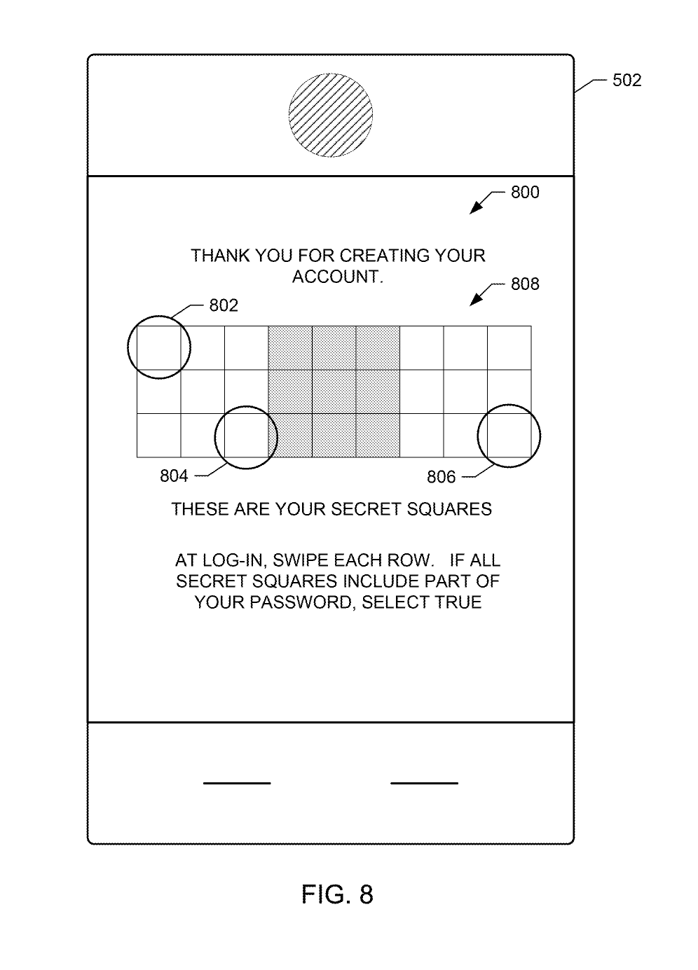

For instance, responsive to a user selecting normal security, the security processor 512 provides the secret login rule 800 to the user, as shown in FIG. 8. The secret login rule 800 includes three designated boxes 802, 804, and 806 in array 808. The security processor 512 also provides a description of the secret login rule 800. This description informs the user how to apply the secret login rule 800 to a login map. In this embodiment, a user is to use the touchscreen of client device 502 to perform a swipe motion across the array 808. This swipe motion causes the client device 502 to display a True/False question. The user is to select True if the designated boxes 802, 804, 806 include a character that is included with a password selected by the user.

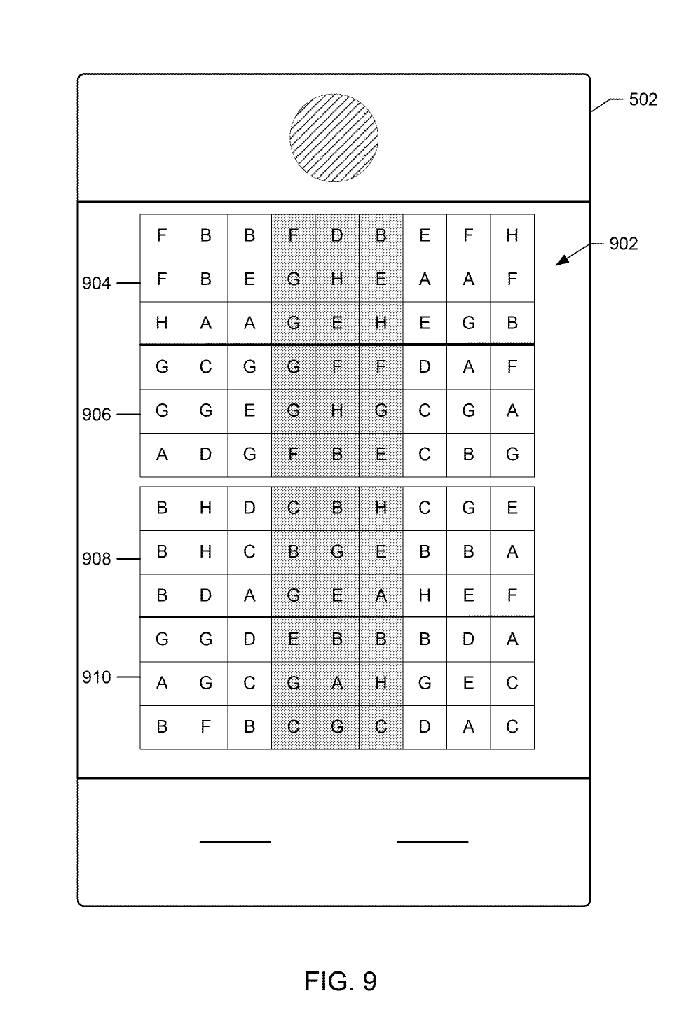

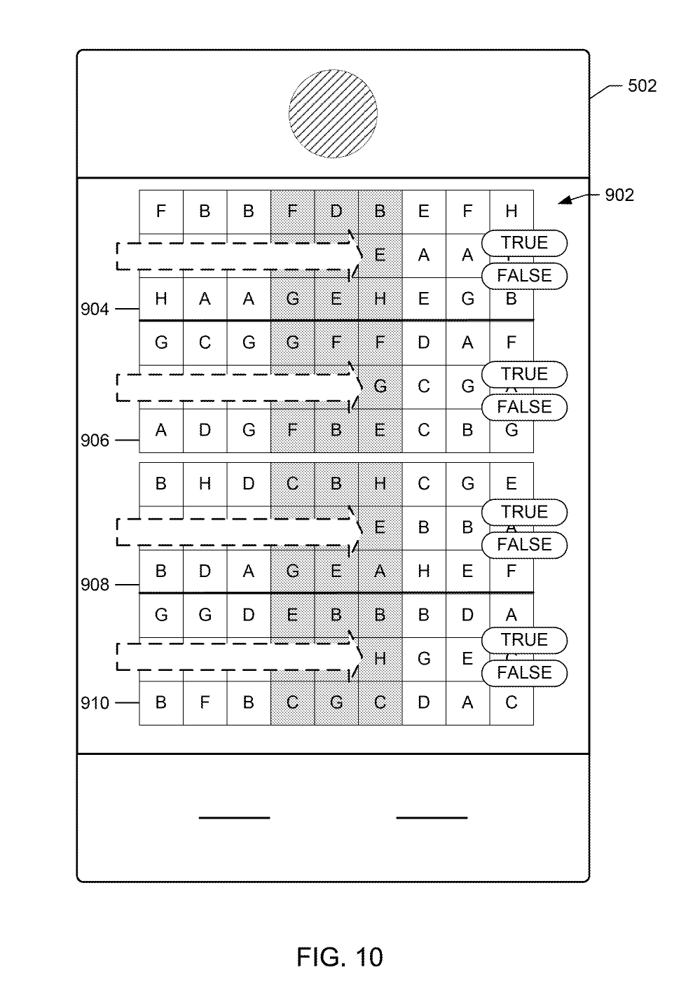

For instance, the user selects password “FABULOUS”. The user would select True if the designated boxes 802, 804, and 806 include letters in the word ‘FABULOUS”. Otherwise, the user would select false. FIGS. 9 and 10 illustrate this example. It should be noted that the example shown in FIG. 8 is only one way a security processor 512 can provide the secret login rule 800. In other embodiments, the security processor 512 can send the user an e-mail or text message with the secret login rule 800. In yet other embodiments, the security processor 512 or the application provider 504 can physically mail a document (e.g., a form or a credit card) including the secret login rule 800 to the user.

FIG. 9 shows client device 502 displaying a login map 902 that includes letters organized into an array. The login map 902 is displayed after a user has provided a username at a login page managed by security processor 512 and/or application server 504. The login map 902 includes separate rows 904, 906, 908, and 910. The user examines the letters within each row at the locations designated by boxes 802, 804, and 806. However, it should be noted that the location of these boxes are not revealed.

To provide an answer for each of the rows 904, 906, 908, and 910, the user performs a swipe motion across the touchscreen of client device 502. FIG. 10 shows the result of the swipe motion for each row 904, 906, 908, and 910. More specifically, swiping each row causes the client device 502 to display a True/False answer option. The user answers each True/False answer option based on whether or not letters from the password “FABULOUS” are included within designated boxes 802, 804, and 806. In this embodiment, the user enters True for rows 904 and 908, and false for rows 906 and 910. The security processor 512 examines the answers for each of the rows, determines that they match the correct answer, and provide the user access to the requested account.

As can be appreciated from FIGS. 9 and 10, the malicious application is not able to observe the authentication information provided by the user. The malicious application is able to detect that a user selected True for two rows and False for another two rows. However, the malicious application does not know why the user selected True or False. The user does not select any of the boxes to give away the location of the designated boxes 802, 804, 806 nor does the security processor 512 highlight the designated boxes 802, 804, 806.

It should also be appreciated that the security processor 512 changes what characters are displayed within each of the boxes of login map. For instance, the security processor 512 may randomize character generation based on characters in the user's password and specifically select characters for some designated boxes so that the user will have to provide at least one true answer. In this manner, each time the same user logs into an account, the login map 902 appears different. For example, the designated boxes can include other letters from the user's password.

It should further be appreciated that the security processor 512 can use different types of characters. For example, the security processor 512 may use text, numbers, graphics, images, patterns of symbols, animations, and/or audible sounds/noises/music. Additionally, while the login map 902 is shown as a rectangular grid or array, in other embodiments the grid can encompass other two dimensional geometries (e.g., triangles, circles, hexagons, ovals, etc.) or three dimensional geometries (e.g., cubes, cylinders, etc.)

It should be noted that the security authentication application shown as being operated by the client device 502 is provided by the security processor 512. For example, the application may be self contained such that only the login map 902 is transmitted to client device 502 and answers to each of the True/False questions are transmitted from the client device 502 to security processor 512. In other embodiments, the client device 502 may transmit a message indicative of the swipe motion causing the security processor 512 to transmits the True/False question to the client device 502.

### Rotary Embodiment

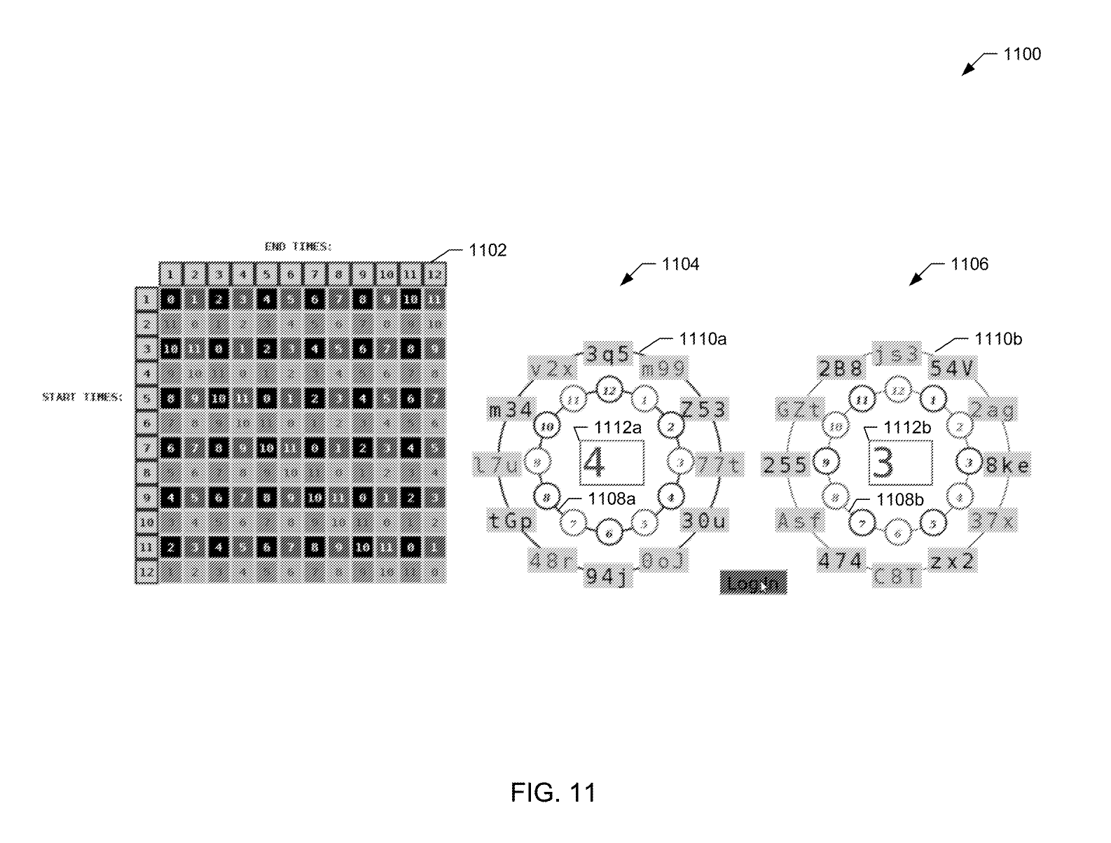

FIG. 11 is a diagram of a rotary login map 1100 embodiment. The login map 1100 includes a key 1102, a first rotary wheel 1104 and a second rotary wheel 1106, which are displayed by a client device 502. In other examples, the security processor 512 may use the key 1102 to determine a correct answer while only the rotary wheels 1104 and 1106 are displayed to a user.

The rotary wheels 1104 and 1106 are used on conjunction with secret login rules provided to a user upon creating an account. For instance, the security processor 512 creates secret login rules that correspond to the structure and functionality of the rotary wheels 1104 and 1106. More specifically, the security processor 512 determines a starting position in an inner ring 1108 (e.g., 1 through 12) an ending position in an outer ring 1110 (e.g., a specific character), and a calculation performed between the starting and ending position (e.g., subtract, add, multiple, solve in an algebraic equation, etc).

For example, the security processor 512 provides a user secret login rules that indicate that the starting position in the inner ring 1108 is at the number ‘3’ and the ending position is the number in the inner ring 1108 that corresponds to a character in the outer ring being ‘8.’ The secret login rules also indicate that the user is to subtract the ending position from the starting position and enter the difference in boxes 1112. Thus, in FIG. 11, the user starts at position ‘3’ in the inner ring 1108 for both rotary wheels 1104 and 1106. For the first rotary wheel 1104, the user determines that the character set ‘48r’ includes the character ‘8,’ which corresponds to ending position ‘7’ on the inner ring 1108a. The user then subtracts ‘3’ from ‘7’ and enters the result of ‘4’ in box 1112a. Similarly, for the second rotary wheel 1106, the user determines that the character set ‘C8T’ includes the character ‘8,’ which corresponds to ending position ‘6’ on the inner ring 1108b. The user then subtracts ‘3’ from ‘6’ and enters the result of ‘3’ in box 1112a.

The security processor 512 receives the numbers entered into boxes 1112 and compares the numbers to a predetermined correct answer. The security processor 512 grants the user access to the requested account if the provided numbers match the correct numbers. It should be appreciated that the client device 502 only transmits the numbers ‘3’ and ‘4’ to security processor 512, which are not part of the user's password. As a result, a malicious application will not be able to access a user's account by providing the same numbers ‘3’ and ‘4’ at a later time because the contents of the login map 1100 will be different. Further, the malicious application does not know what secret login rules the user applied to arrive at the numbers ‘3’ and ‘4.’ Accordingly, the security processor 512 is able to provide authentication that is observable to the user and not observable to the malicious application.

It should also be appreciated that each time the user logs into the account, the security processor 512 changes the characters in the outer rings 1110 and the numbering of the inner rings 1108. For example, the number of the inner ring 1108a can be changed such that the order of the numbers is randomized (e.g., 1, 5, 3, 10, 8, 2, 4, 6, 12, 7, 9, 12). Further, it should be appreciated that the security processor 512 can assign different starting positions, ending positions, and computations to different users.

### Dot-Matrix Embodiment

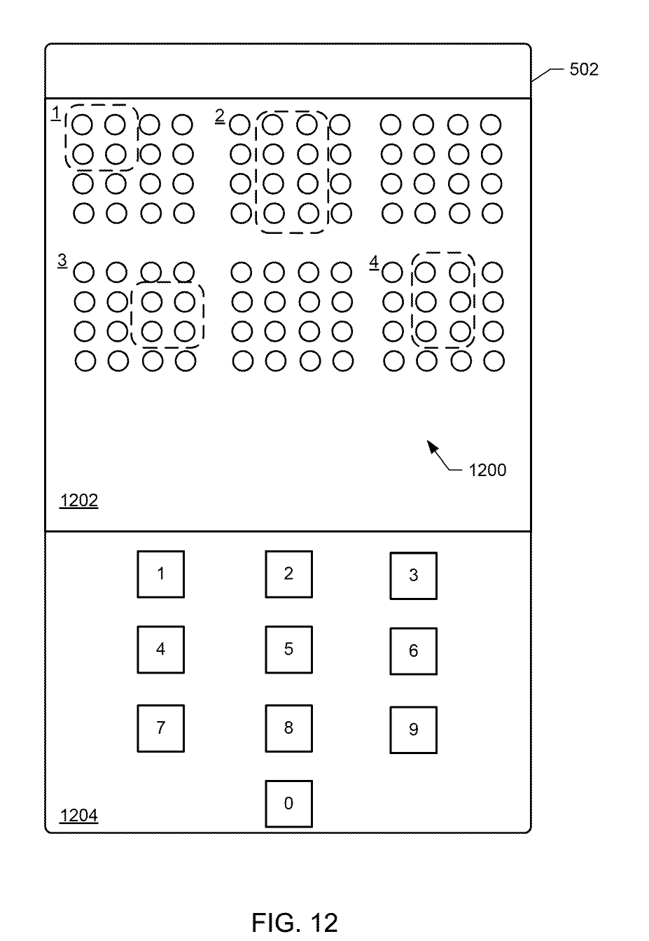

FIGS. 12 to 14 are diagrams of a dot-matrix grid login map 1200 embodiment. In FIG. 12, the client device 502 includes a login map area 1202 and a keypad 1204. In this manner, the client device 502 could include any check-out credit card machine and the login map 1200 is used as a pin or authentication number to provide additional credit card security.

In FIG. 12, a user has selected a level of security (e.g., light, moderate, strong) and is shown a secret login rule 1206. The secret login rule 1206 is a set of dots (e.g., dots corresponding to boxes 1, 2, 3, 4) in some of the groups for which the user is to provide an answer as to how many of the dots are shaded (or un-shaded). The secret login rule also includes the order as to which the user is to enter the number of dots in each box.

It should be appreciated that while FIG. 12 shows the secret login rules including symbols arranged in rectangles, other examples can include columns, rows, diagonals, triangles, L-shapes, T-shapes, staircases, etc. For instance, the box 2 could be replaced by a triangle shape that encompasses three dots. In some embodiments, the security processor 512 may enable a user to select the shape used for the secret login rule. Alternatively, the shape may be selected by the security processor 512 based on the level of security selected by the user.

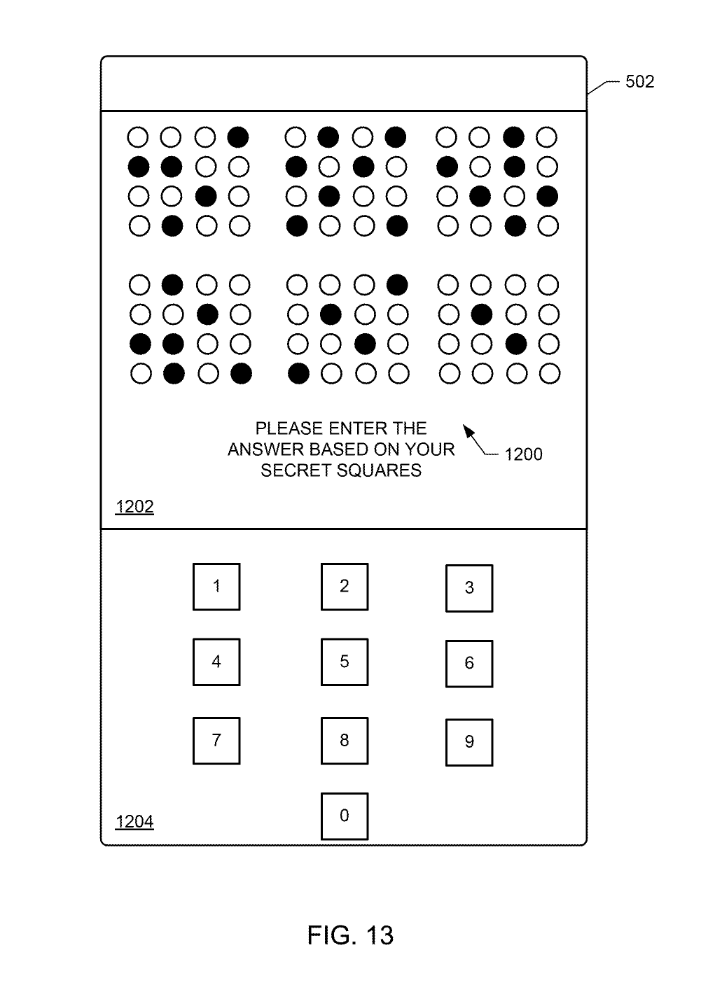

In an example, FIG. 13 shows the client device 502 providing observable authentication using the dot-matrix login map 1200. The user examines the dots in boxes 1, 2, 3, and 4. It should be appreciated that the location of the boxes is not shown or provided to the user (i.e., the user has already received the location of the boxes at some previous time, as shown in FIG. 12). As a result, a malicious application (or malicious camera) cannot determine which areas of the login map 1200 are part of the authentication and which areas are not part of the authentication.

In this example, the user would enter in keypad 1204 a ‘2’ corresponding to the number of shaded dots in box 1, a ‘3’ corresponding to the number of shaded dots in box 2, a ‘1’ corresponding to the number of shaded dots in box 3, and a ‘2’ corresponding to the number of shaded dots in box 4. Responsive to entering the numbers, the security processor 512 grants the user access to proceed with the transaction. It should be appreciated that the security processor 512 changes the pattern of which dots are shaded within the login map 512 each time the user executes a transaction.

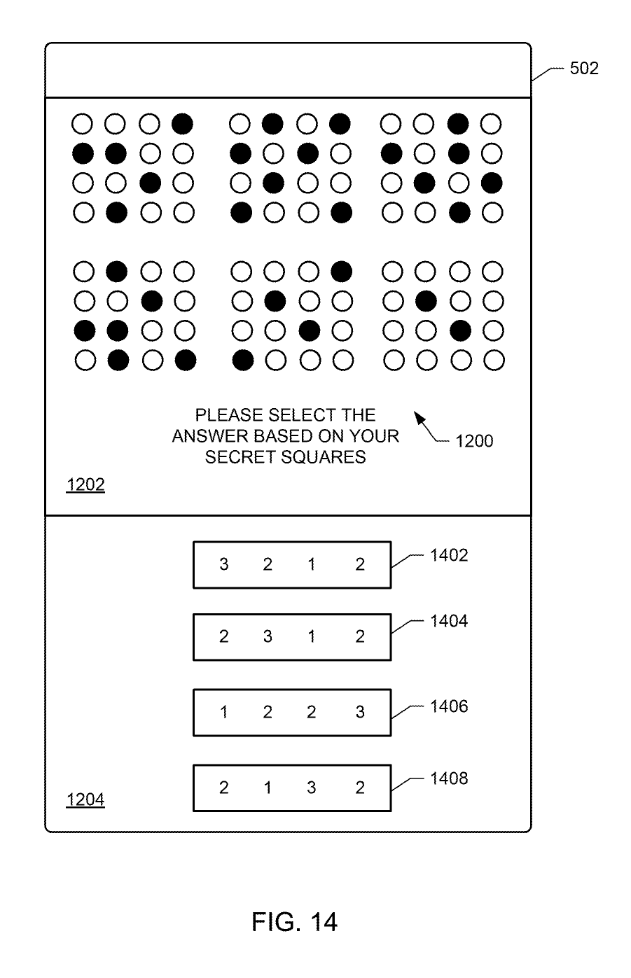

FIG. 14 is another embodiment using the dot-matrix login map 1200. In this embodiment, the numeric keys in the keypad 1204 are replaced with selection keys 1402, 1404, 1406, and 1408. The user is prompted to select which of the keys correspond to the number of shaded dots in the correct order of boxes. In this example, the user would select key 1404 as the correct answer. Using this configuration, the security processor 512 is able to change which key corresponds to the correct answer, thereby further complicating detection for a malicious application.

### Data Structure of Secret Login Rules

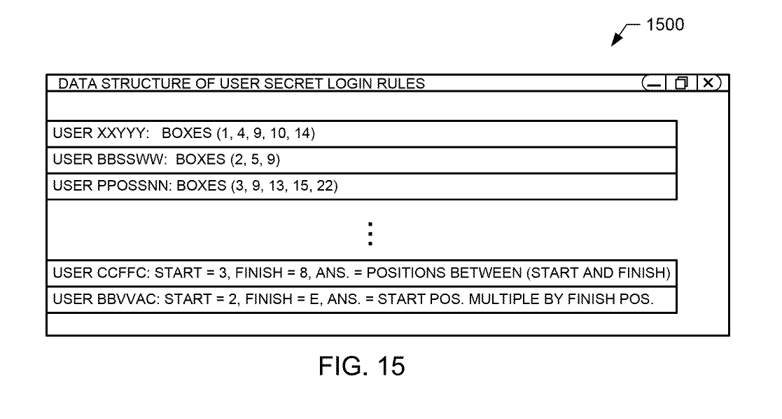

FIG. 15 shows a diagram of a data structure 1500 that is used by the example security processor 512 to store secret login rules for different users. The data structure 1500 is only one possible embodiment of how secret login rules can be stored. For instance, in other embodiments secret login rules can be stored by rule type and/or account/service provider. Further, the secret login rules can be encrypted.

The example security processor 512 uses the secret login rules in data structure 1500 to determine a correct answer to a login map provided to a user. Thus, the secret login rules are not communicated during a transaction or account access but instead are independently stored or known by the user and the security processor 512. The only information that is exchanged is the feedback or answer to the login map.

In FIG. 15, secret login rules 1502, 1504, and 1506 correspond to three different users for the grid login map 902 described in conjunction with FIGS. 9 and 10. The numbers next to the word ‘Boxes’ correspond to the position of designated boxes within the grid login map for each of the users. The number of designated boxes differs for each user based on the level of security selected by the user.

Thus, when user XXYYY accesses an account, the security processor 512 uses the box locations for placing characters of the user's password in a login map. The security processor 512 also uses the box locations to determine whether each row of the login map includes characters from the user's password, which corresponds to the True/False answer provided by the user. It should be appreciated that security processor 512 can only change the box locations by notifying the user.

The data structure 1500 also includes secret login rules 1508 and 1510, which correspond to the rotary login map 1100 described in conjunction with FIG. 11. Here, the login rules 1508 and 1510 include the start position, the end position, and the calculation to be performed by the user based on the start and end positions. For instance, user CCFFC starts at the number ‘3’ searches for a position that includes character ‘8’ and subtracts the difference between the start and finish positions.

### Flowchart of the Example Process

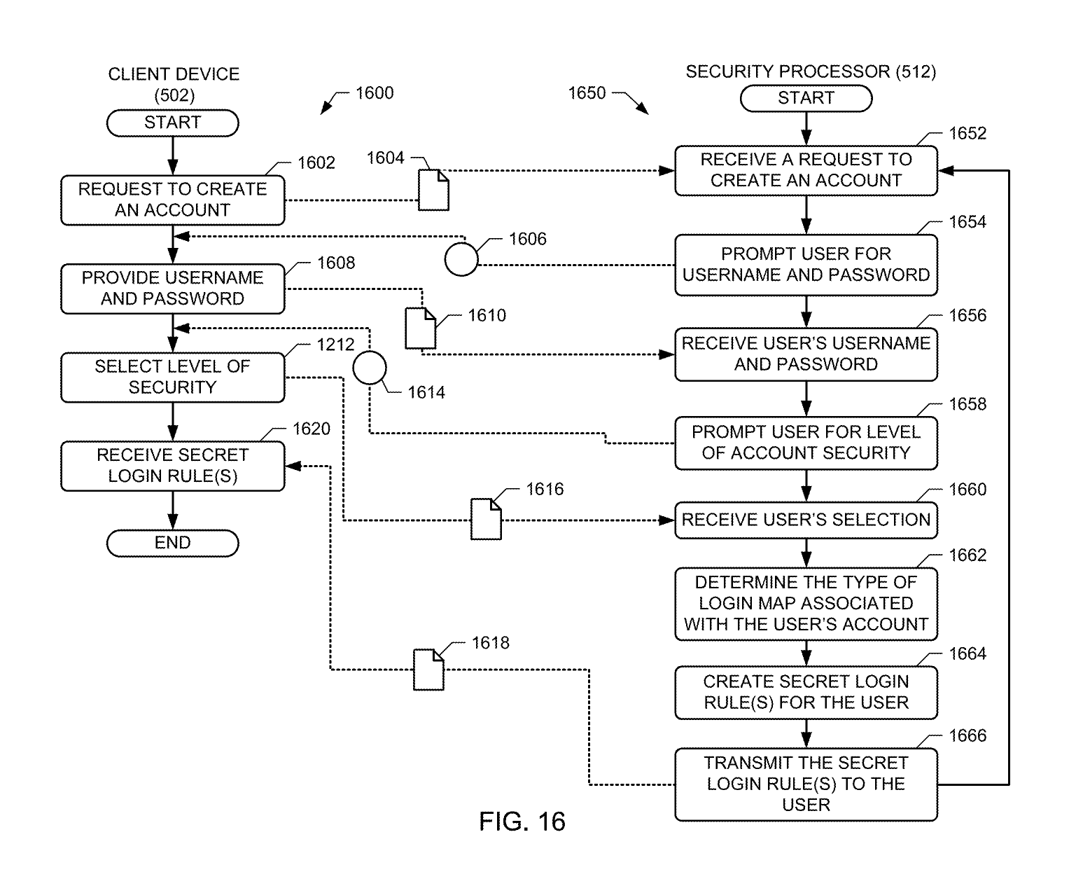

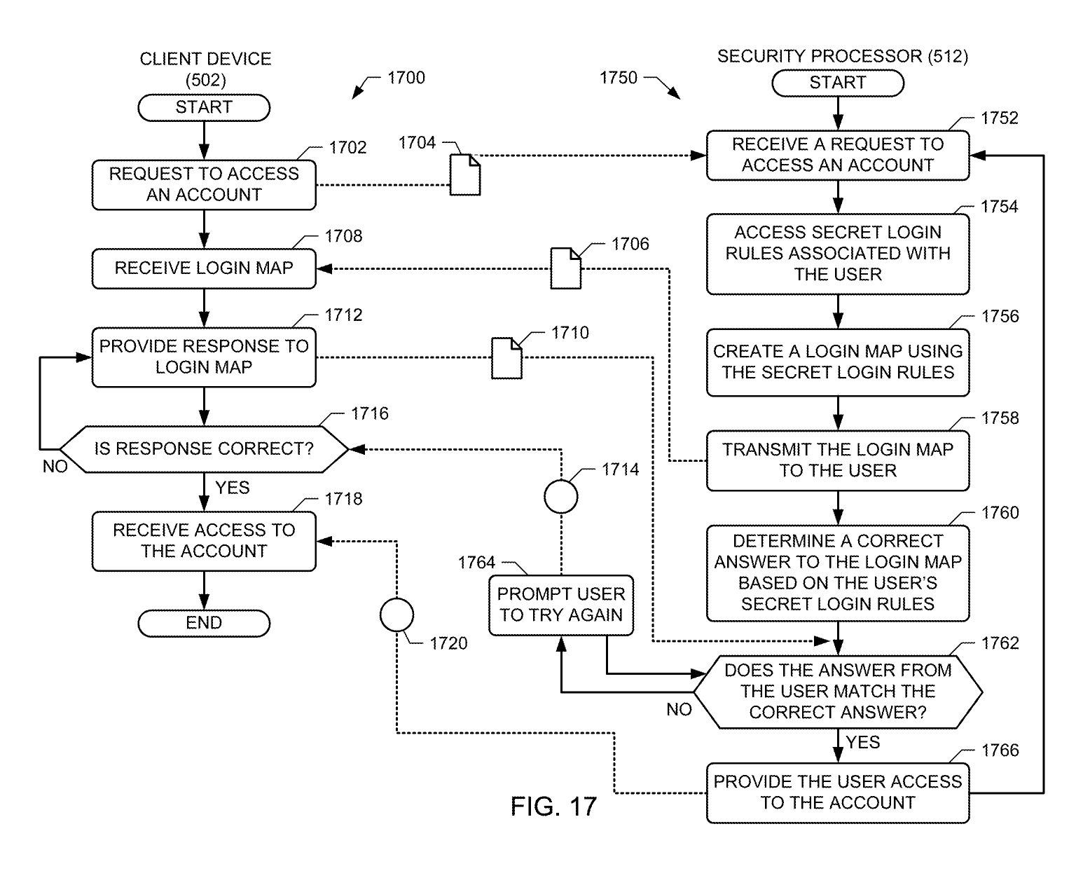

FIGS. 16 and 17 illustrate flow diagrams showing example procedures 1600, 1650, 1700, and 1750 to provide observable authentication, according to an example embodiment of the present invention. Although the procedures 1600, 1650, 1700, and 1750 are described with reference to the flow diagram illustrated in FIGS. 16 and 17, it will be appreciated that many other methods of performing the steps associated with the procedures 1600, 1650, 1700, and 1750 may be used. For example, the order of many of the blocks may be changed, certain blocks may be combined with other blocks, and many of the blocks described are optional. Further, the actions described in procedures 1600, 1650, 1700, and 1750 may be performed among multiple devices including, for example client devices 502 and security processors 512.

The example procedure 1600 operates on, for example, the client device 502 of FIGS. 5 and 6. The procedure 1600 begins when the client device 502 transmits a request 1604 to create an account (block 1602). The request 1604 may be transmitted to security processor 512 either directly or indirectly via an application server 504 hosting a service/information for which the user is creating an account. Responsive to receiving a prompt 1606 (e.g., a message) to provide a username and password, the client device transmits a username and password 1610 to security processor 512 (block 1608). The client device 502 may also transmit additional information needed to create an account including for example, billing and address information.

The example procedure continues 1600 when a user of the client device 502 selects a level of security responsive to receiving a prompt 1614 (block 1612). The client device 502 transmits a message 1616 indicative of the selected level of security. The client device 502 then receives one or more secret login rules 1618 from the security processor 512 (block 1620). At this point the procedure 1600 ends and the user may use the secret login rules 1618 to access the content associated with the newly created account.

The example procedure 1650 operates on, for example, the security processor 512 of FIGS. 5 and 6. The procedure 1650 begins when the security processor 512 receives a request 1604 to create an account from a client device 502 (block 1652). The security processor 512 then prompts the user for a username and password via prompt 1606 (block 1654). The security processor 512 next receives the user's username and password 1610 (block 1656).

Responsive to receiving the username and password 1610, the security processor 512 transmits a prompt 1614 requesting that the user select a level of security for the account (block 1658). The security processor 512 then receives a response 1616 indicating the user's selection of the level of security (block 1660). The security processor 512 then determines the type of login map associated with the user's account (block 1662). In some instances, a service provider may specify the type of login map that is to be used for user accounts. For example, a banking company may select a grid login map type for individual consumer accounts and a rotary login map type for corporate accounts. In other instances, the security processor 512 may select a login map type based on the level of security provided by the user. Alternatively, a user may select the specific login map type.

The example procedure 650 continues by the security processor 512 creating secret login rules 1618 for the user appropriate for the login map type (block 1664). The example security processor 512 creates the secret login rules using routines or algorithms that are predefined based on the type of login map. For instance, an algorithm for a rotary login map may instruct the security processor 512 to select any starting value between one and twelve, any alpha-numeric character, and a pre-approved mathematical operation (e.g., addition, subtraction, multiplication, etc.). The security processor 512 further creates the secret login rules in part by using, for example, the level of security 1616 provided by the user. For instance, a selection of a greater amount of security causes the security processor 512 to identify seven boxes in a grid login map.

After creating the secret login rules 1618, the security processor 512 stores the rules to a data structure and transmits the rules to the user (block 1666). In some embodiments the transmission may be via an electronic medium (e.g., e-mail, webpage, text message, etc.). In other embodiments, the transmission may be through a physical medium (e.g., post office mail). The example procedure 1650 continues by returning to block 1652 to create an account for another user. In other embodiments, the example procedure 1650 terminates after providing the secret login rules 1618 to the user.

The example procedures 1700 operates on, for example, client device 502. The example procedure 1700 begins by the client device 502 transmitting a request 1704 to access an account (block 1702). The request 1704 includes, for example, a username associated with the user, a web address of an account to be accessed, a name of a service/account/application provider, etc. The client device 502 then receives and displays a login map 1706 (block 1708).

A user of the client device 502 reads the login map 1706 and determines a response 1710. The user than instructs the client device 502 to transmit the response 1710 (block 1712). The client device 502 receives a message 1714 indicating whether the response 1710 was correct (block 1716). If the response 1710 was not correct, the client device 502 prompts the user to enter another response (block 1712). However, if the message 1714 indicates that the user's response 1710 is correct, the client device 502 receives access 1720 to the account (block 1718). At this point, the user is able to access and view data associated with the account and the procedure 1700 terminates.

The example procedure 1750 operates on, for example, the security processor 512 and begins when a request 1704 is received to access an account (block 1752). The security processor 512 uses, for example, a username included within the request 1704 to search a data structure for secret login rules associated with the username (block 1754). The security processor 512 next uses the secret login rules to create an appropriate login map 1706 (block 1756). As discussed above, creating the login map includes generating characters (e.g., observable information) in such a manner that a user is able to provide an answer by viewing the characters in combination with the secret login rules. In other words, the security processor 512 constructs the login map to ensure that a definite result is possible. The security processor 512 then transmits the login map 1706 to the client device 502 (block 1758).

The example procedure 1750 of FIG. 17 continues by the security processor 512 determining a correct answer to the login map 1706 based on the user's secret login rules (block 1760). The security processor 512 then compares a response 1710 received from the client device 502 to the determined correct answer (block 1762). If the response 1710 does not match, the security processor 512 transmits a message 1714 prompting the user to provide another response (block 1764). The security processor 512 may allow a user to provide a predefined number of responses that do not match the correct answer before the user is locked out of the account. In some examples, the security processor 512 may provide the user another login map (e.g., a login map with different observable information) upon determining the user has provided an incorrect response. The different login map prevents, for example, a malicious application from trying a number of different responses for the same configuration of observable information in a login map.

However, if the user's response 1710 matches the correct answer (block 1762), the security processor 512 provides the user access 1720 to the account (block 1766). In other embodiments, the security processor 512 may instruct an application processor 504 to provide the client device 502 access to the requested account. At this point, the procedure 1750 returns to block 1752 to provide another user access to a different account. In other embodiments, the example procedure 1750 terminates after providing the client device 502 access to the account.

### Crypto-Grid Embodiment

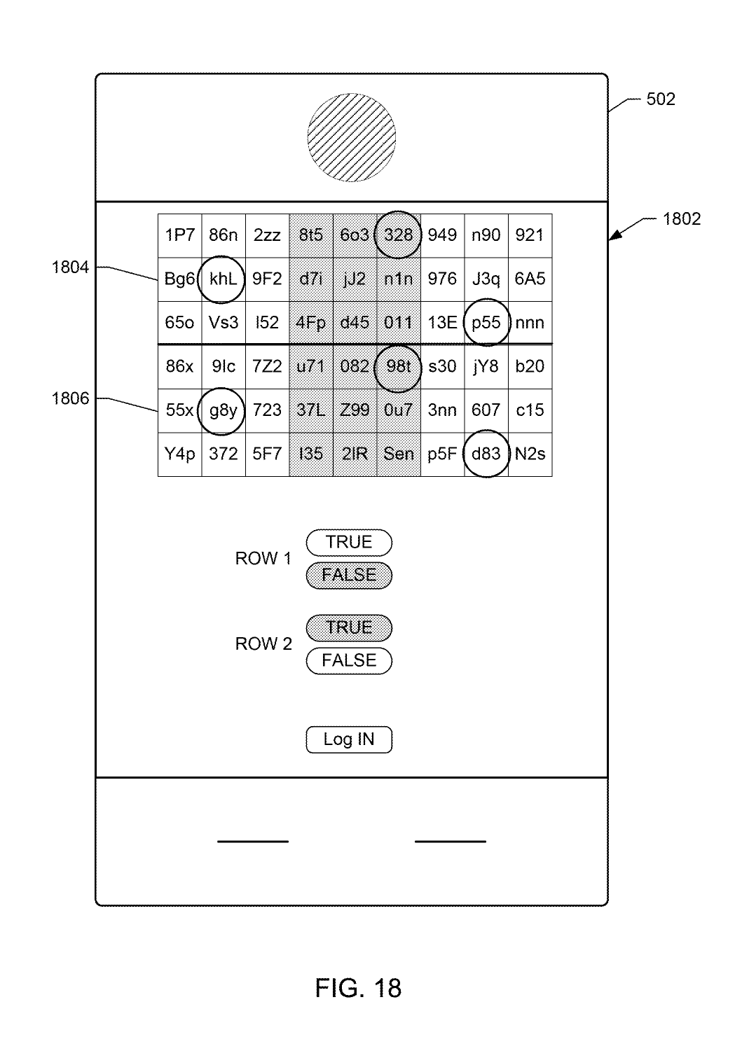

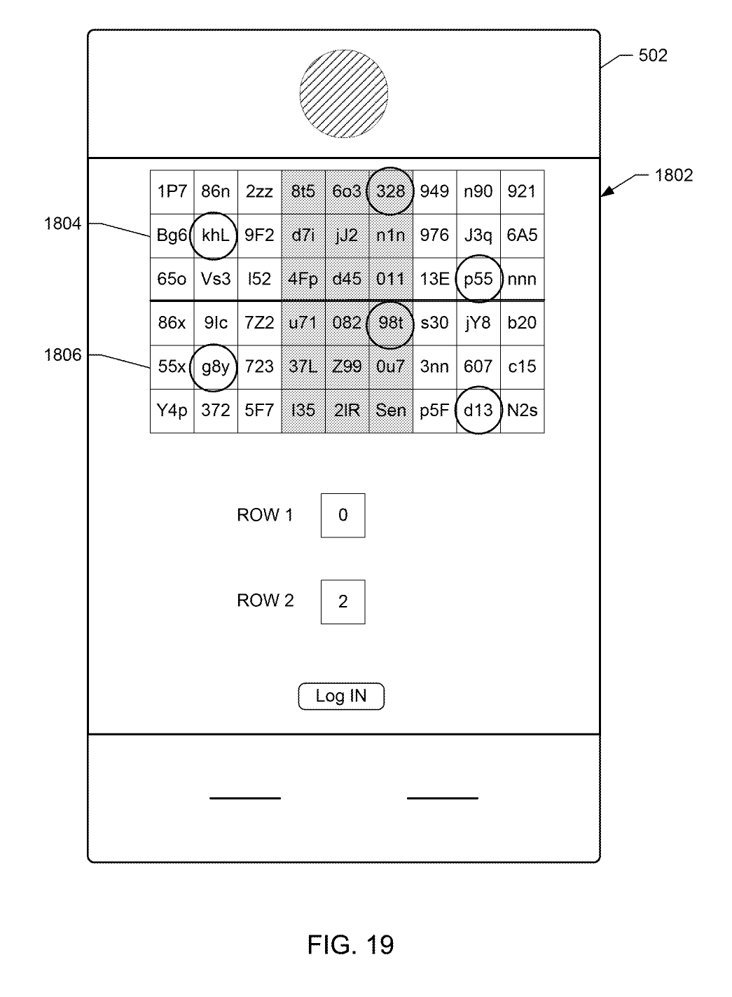

FIGS. 18 and 19 are diagrams of a crypto-grid login map 1802 embodiment. In this embodiment, the login map includes two rows 1804 and 1806 of boxes, each box including three characters randomly generated by the security processor 512. A user is assigned a secret login rule that identifies designated boxes (the boxes shown in FIG. 18 as being circled). The secret login rule also specifies that for each designated box in the rows, the middle character has to be an ‘8’. While FIG. 18 shows characters within the grid boxes, in other embodiments, the grid boxes can include symbols or other markings (e.g., musical notes).

In FIG. 18, the user examines the designated boxes in rows 1804 and 1806 to determine if the middle character is ‘8’. If each of the designated boxes in the row have a middle character of ‘8,’ the user selects true. Otherwise, the user selects false. It should be appreciated that the boxes are circled for convenience and that in actual use the boxes would not be circled.

The login map 1802 of FIG. 19 is the same login map 1802 of FIG. 28. However, instead of answering true/false (as in the embodiment of FIG. 18), the security processor 512 in the embodiment of FIG. 19 assigns the user a secret login rule that specifies the user is to enter a number of designated boxes in each row 1804 and 1806 that includes a middle character of ‘8.’ Thus, in the illustrated embodiment, the user enters a ‘0’ for row 1 and a ‘2’ for row 2. It should be appreciated that FIGS. 18 and 19 show that different secret login rules can be applied for the same login map 1802, thereby reducing the possibility of detection by a malicious application.

### Combination Embodiment

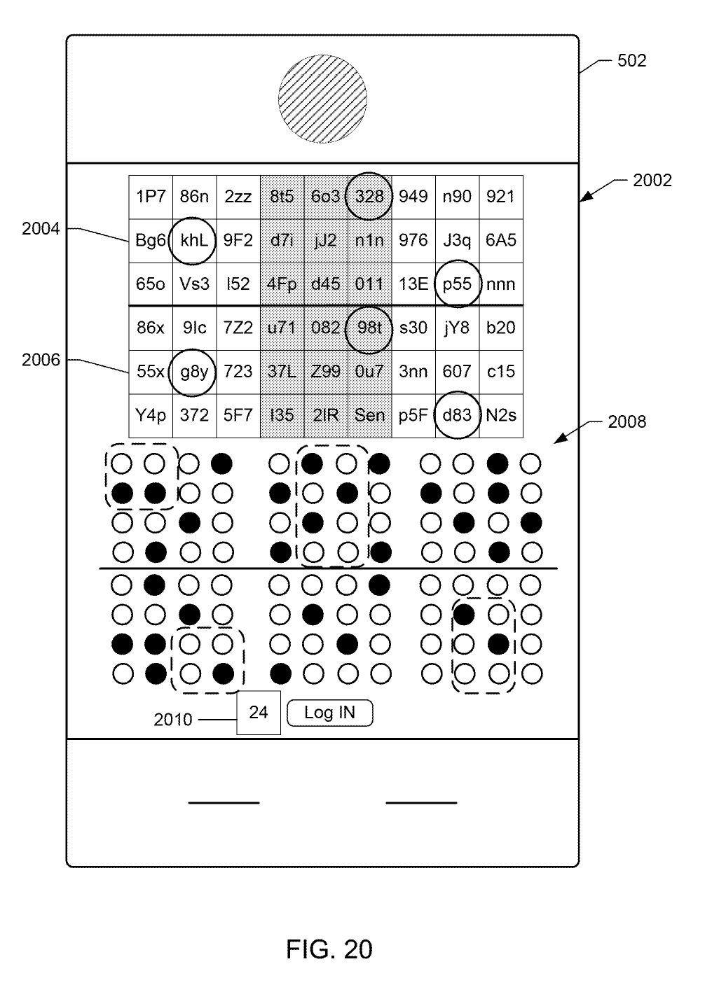

FIG. 20 shows a diagram of a combination login map 2002 embodiment. The login map 2002 includes crypto-grid rows 2004 and 2006, similar to rows 1804 and 1806 of FIGS. 18 and 19. The login map 2002 also includes a dot-matrix portion 2008, similar to the dot matrix login map 1200 of FIGS. 12 to 14.

FIG. 20 shows that the security processor 512 may combine different types of login maps to create more complex login maps. For instance, the security processor 512 may provide login map 2002 for a user that selects a greater level of security. The combination of login maps increases a data burden on a malicious application causing it to acquire many more observation points before forming a hypothesis regarding the secret login rules.

In the illustrated example, the security processor 512 assigns a user a secret login rule that specifies a user is to count the number of designated boxes that include an ‘8’ as a middle character. For convenience, the designated boxes are circled. Another secret login rule specifies that the user is to count the number of shaded dots within designated boxes in the dot-matrix portion 2008. For convenience, the designated boxes are highlighted. A further secret login rule specifies that the user is to multiply the first count by the second could and enter the result in box 2010. Upon providing the correct number, the security processor 512 grants or provides the user access to the requested account.

### Character Grid Embodiments

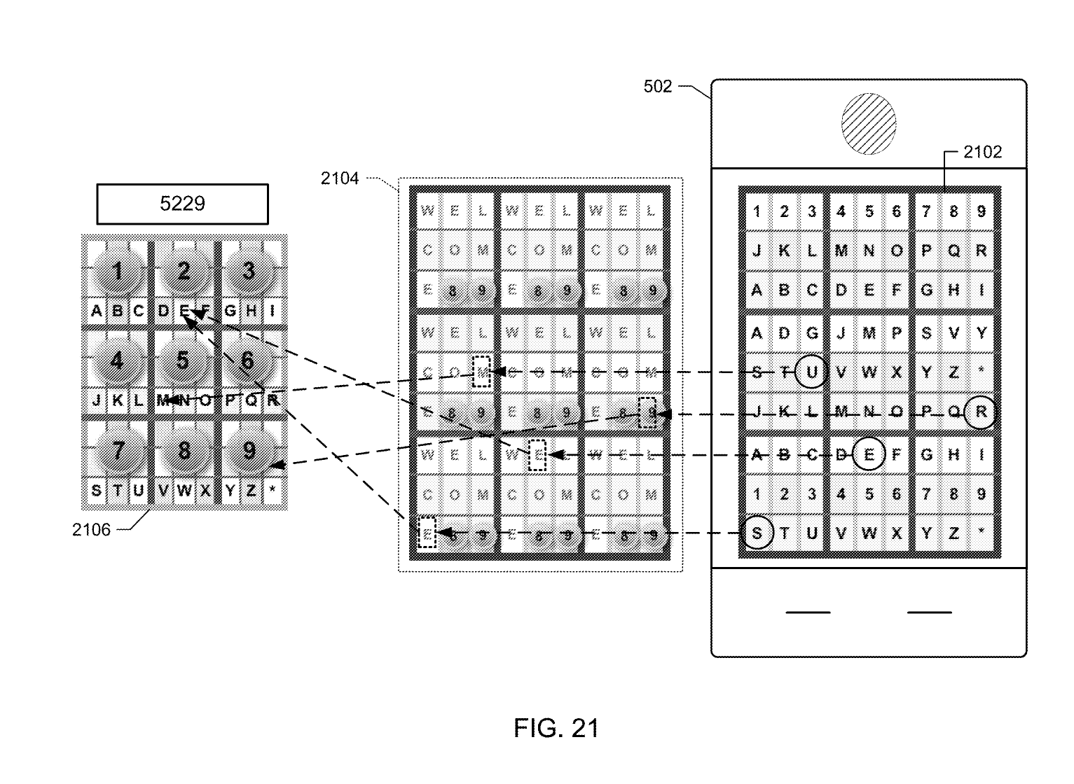

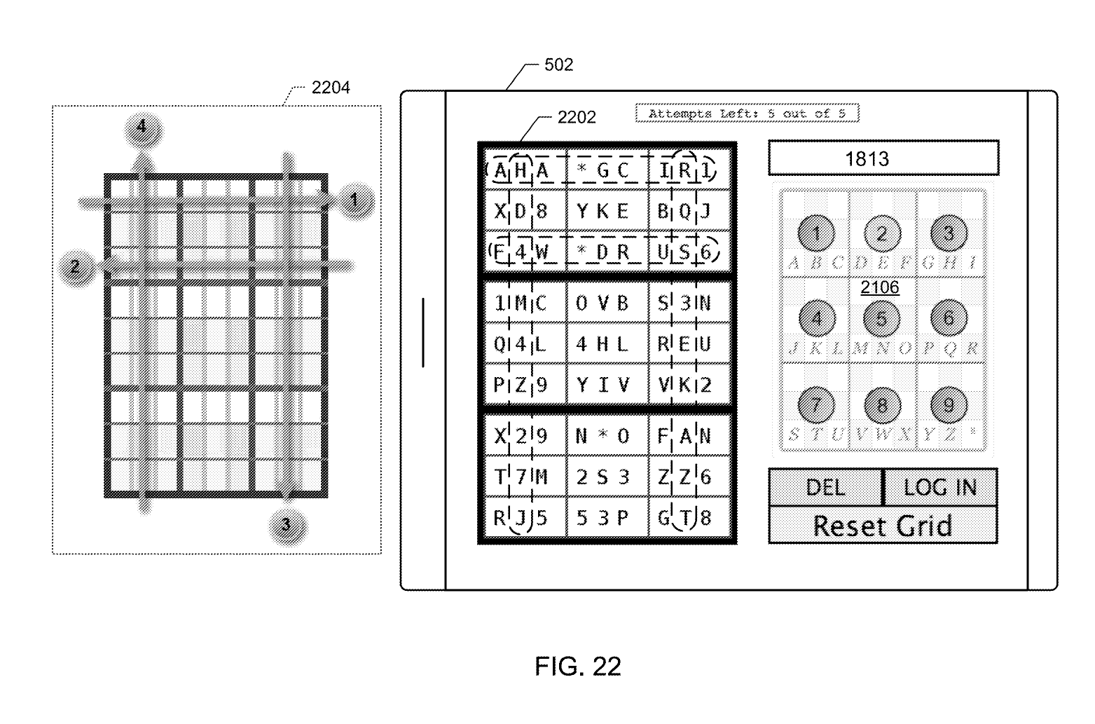

FIGS. 21 and 22 show diagrams of example character grid login map embodiments. A login map 2102 includes numbers and letters arranged in a matrix. In this embodiment, a user is prompted to provide a first phrase and a second phrase. In other examples, the user is assigned first and second phrases. The first phrase is used as part of a secret login rule 2104. The second phrase is used by a user to determine an answer from a login map 2102 using the secret log rule 2104.

For example, in the illustrated example of FIG. 21, a user selects “welcome” as a first phrase and “user” as a second phrase. The example security processor 512 of FIG. 5 uses the first phrase as a repeating code within the secret login rule 2104. The security processor 512 provides the secret login rule 2104 to the user through a secure electronic communication medium and/or through physical mail. In some embodiments, the security processor 512 may provide the secret login rule to a credit card company, which prints at least a portion of the secret login rule on a credit card.

When a user attempts to access an account for which the secret login rule 2104 was created, the client device 502 of the user receives the login map 2102. As discussed above, the login map 2102 includes characters that are randomly placed and/or generated based at least in part on the user's second phrase. In other words, the security processor 512 generates the login map 2102 so that it includes at least one instance of the characters within the second phrase among other randomly generated characters.

In this example, the user searches for characters within the login map 2102 that match characters from the second phrase (e.g., the characters ‘U’, ‘S’, ‘E’, and ‘R’). It should be noted that the login map 2102 can include multiple instances of those characters. However, only one of the characters needs to be selected by the user. In this example, the security processor 512 accordingly determines that there is more than one correct answer to access the account.

After locating the characters on the login map 2102, the user determines corresponding characters on the secret login rule 2104. For instance, the user determines that the character ‘U’ from the login map 2102 corresponds to the character ‘M’ of the secret login rule 2104. It should be noted that the client device 502 does not display the secret login rule 2104. Instead, the secret login rule 2104 is committed to a user's memory or is stored separately from the client device 502.

Once a user has determined the characters on the secret login rule 2104, the user determines a corresponding number on a numeric keypad 2106. This action may be specified as a second step of the secret login rule 2104 or, alternatively, a separate secret login rule. The example keypad 2106 may be included within the client device 502. Alternatively, the keypad 2106 may be included at a point of sale terminal or an automated teller machine.

In the example from above, the user determined that the character ‘M’ from the secret login rule 2104 corresponds to the number 5. The user accordingly enters the number 5 into the keypad as the first digit of the answer. In this example, the user determines that the characters ‘S’ and ‘E’ from the login map 2102 correspond to the character ‘E’ on the secret login rule 2104, which corresponds to the number 2. The user also determines that the character ‘R’ from the login map 2102 corresponds to the character ‘9’ on the secret login rule 2104, which corresponds to the number 9 on the keypad 2106. The user then submits the answer ‘5229’ to the security processor 512 (or website hosting the content to be accessed) via the client device 502.

FIG. 22 shows a second embodiment using a character grid login map 2202. Similar to the login map 2102 of FIG. 21, the character grid login map 2202 of FIG. 22 includes characters that are randomly placed and/or generated in a matrix or chart by the security processor 512. However, in this example, a user determines whether letters of a key phrase are included within predefined rows or columns.

For example, the security processor 512 prompts a user to select one or more rows/columns as part of a secret login rule 2204. In FIG. 22, a user selects (or is provided with) two rows and two columns for the secret login rule 2204. The numbers next to each row/column correspond to the order in which the user is to provide an answer. For instance, the user first scans the row labeled ‘1’ and provides an answer before scanning the row labeled ‘2’. While the secret login rule 2204 and the login map 2202 is shown as being a two-dimensional grid, in other embodiments the map and rule may encompass a three-dimensional grid.

The security processor 512 also prompts the user to provide a key phrase, which is also used as part of the secret login rule 2204 and in generating the characters for the login map 2202. In this example, the user selects the key phrase ‘Chicago8.’ The user uses the key phrase by searching in each of the rows/columns specified by the secret login rule 2204 for characters that match characters within the key phrase.

In the illustrated example of FIG. 22, the user uses the client device 502 to access an account. The security processor 512 associated with the account provides the login map 2202. It should be noted that the highlighted boxes corresponding to the secret login rows/columns are shown for illustrative purposes only. In an actual implementation, the boxes would not be shown to the user.

In this example, the user applies the key phrase and the secret login rule 2204 to the characters in the login map 2202. First, the user scans the first row to determine how many of the characters of the key phrase ‘Chicago8’ are included within the row (e.g., only 1 character). The user types this answer into the keypad 2106. The user continues for the second row, the third column, and the fourth column to generate the answer ‘1813’. The user then transmits the answer, via the client device 502, to the processor or server hosting the account. Responsive to providing a correct answer, the client device 502 is provided assess to the account.

### Scan Pattern Character Grid Embodiment

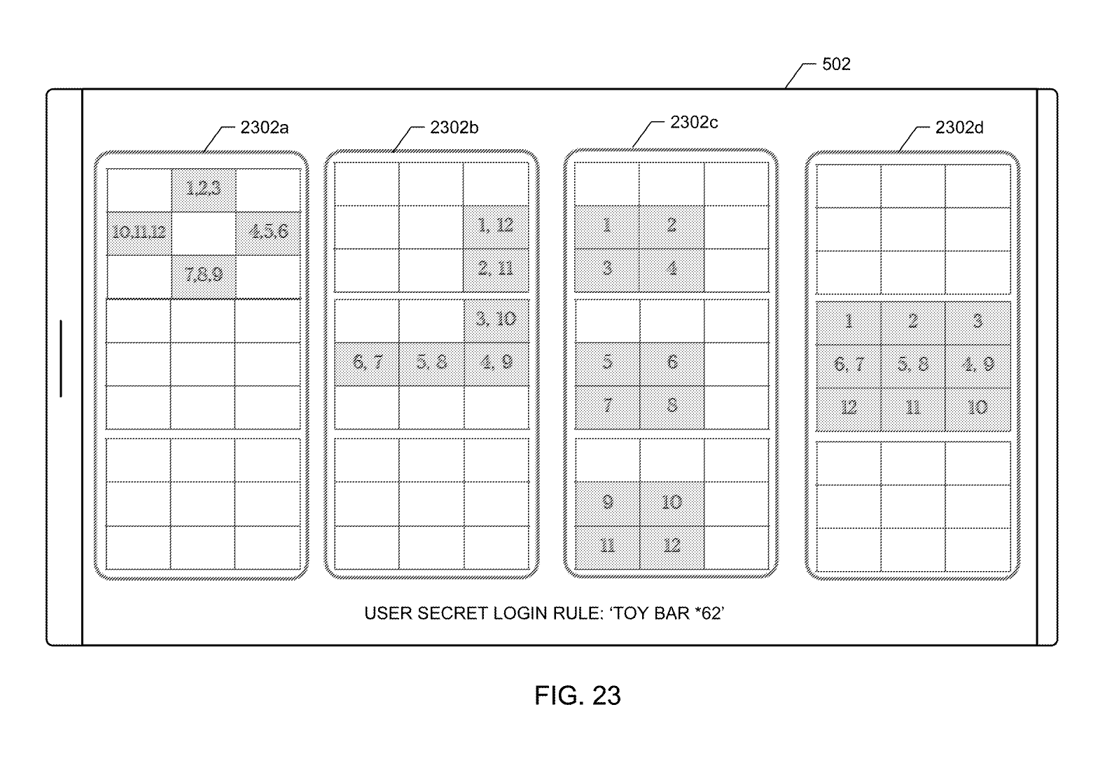

FIGS. 23 to 25 show diagrams of a scan pattern character grid embodiment. This embodiment shows a relatively complex level of security that uses three different secret login rules to arrive at a four character answer. It can be appreciated that the scan pattern character grid described in conjunction with FIGS. 23 to 25 is relatively more complex (and secure) than the character grids described in conjunction with FIGS. 21 and 22

In this embodiment, the secret login rules provide a series of steps that describe how a user is to progress through a character grid login map to determine an answer. The secret login rules also includes actions a user is to perform in conjunction with the character grid login map based how many characters match a key phrase determined by a user. The secret login rules are also applied more than once during the process to determine the correct answer.

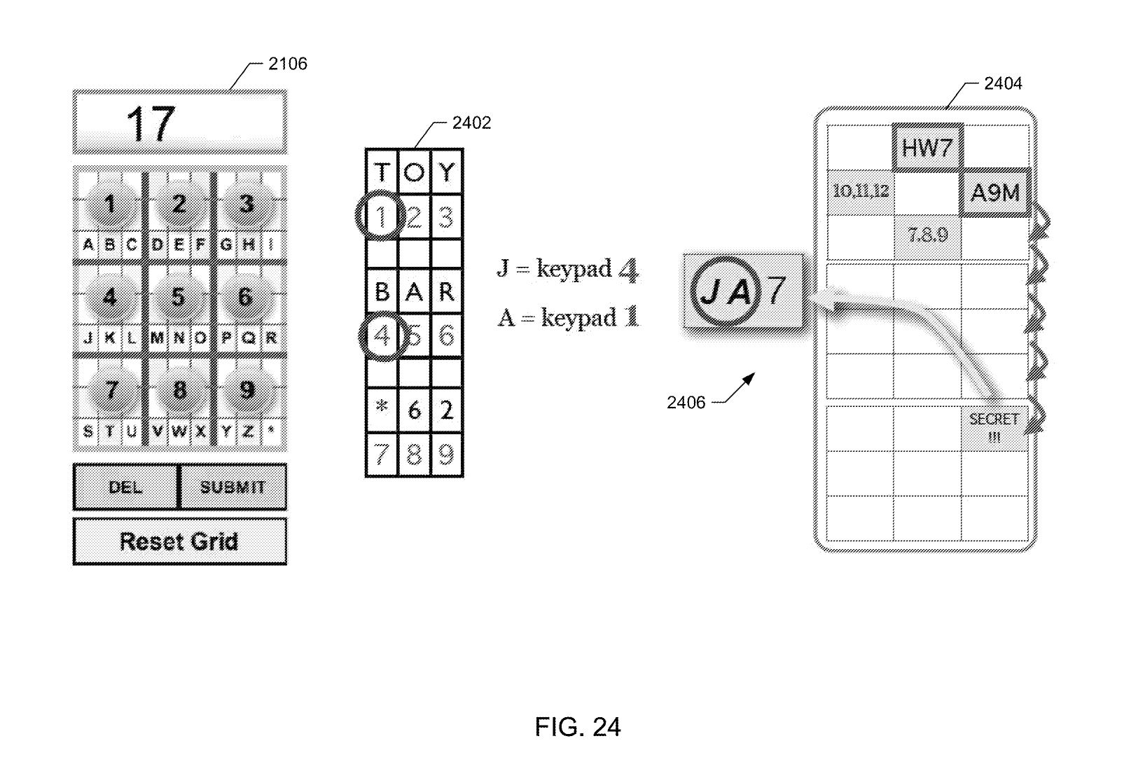

FIG. 23 shows a diagram of a client device 502 displaying account authentication setup information. As discussed above, the setup information is provided by a security processor 512 associated with the account. The account authentication setup information includes secret login rules 2302a, 2302b, 2302c, 2302d. The security processor 512 prompts a user to select one of the login rules 2302. The security processor 512 also prompts the user to provide a key phrase. In this example, the user provides the key phrase ‘toy bar*62’ and selects the secret login rule 2302a. The security processor 512 assigns each letter of the key phrase a number to form a second secret login rule, which is described in more detail in conjunction with FIG. 24.

In this embodiment, the numbering within each of the boxes in the grid correspond to an order in which a user is to scan through a login map. For instance, in the secret login rule 2302a, a user would first determine if the first character of the top center box includes a character that matches a character in the user's key phrase. If the answer is yes, the user is to move down (or in any other direction) a certain number of boxes and apply a second secret login rule to determine an answer. If the answer is no, the user progresses to the second letter of the top center box and determines whether a character that matches a character in the user's key phrase. The user repeats this process (e.g., stepping though the numbered locations) until there is match between a character and a character in the user's key phrase or the user has reached position twelve. After a user has reached position twelve, the answer provided to the security processor corresponds to the one or more characters at the twelfth position. In instances where a secret login rule includes only one or two numbers in a box, a user scans the corresponding first or second character in the box of the login map.

FIG. 24 shows a diagram of a user applying the secret login rule 2302a and a second secret login rule 2402, which includes the key phrase ‘toy bar*62’ of FIG. 23 to a login map 2404. For convenience, only relevant characters are displayed within the login map 2402. In an actual implementation, the login map 2404 would include one or more characters within each of the boxes. In this example, a user has already stepped through the first three positions because the key phrase ‘toy bar*62’ does not include the characters ‘H’, ‘W’, or ‘7’.

At position four, the user determines that the character ‘A’ is included within the key phrase. The user applies the second secret login rule 2402 to determine that the character ‘A’ corresponds to the number 5. The user then moves down five boxes (according to a first step of a third secret login rule 2406) and analyzes the characters in this box (e.g., ‘J’, ‘A’, and ‘7’). The third secret login rule 2406 also specifies (in a second step) that the user is to only use the first two characters of this box. The third secret login rule 2406 further specifies (in a third step) that the user is to determine a keypad number that corresponds to the character. In this example, the user is provided all three secret login rules 2302a, 2402, and 2406 during account registration or authentication setup.

Continuing with this example, the user determines the number 4 is the keypad number corresponding to the character ‘J’ and the number 1 is the keypad number corresponding to the character ‘A’. The user then applies the second login rule 2402 to these numbers to determine that the character ‘B’ of the key phrase corresponds to the number 4 and the character ‘T’ of the key phrase corresponds to the number 1. The user than determines that the character ‘B’ corresponds to the number 1 on the keypad 2106 and enters that number as part of the answer. The user next determines that the character ‘T’ corresponds to the number 7 on the keypad 2106 and enters that number as the second part of the answer.

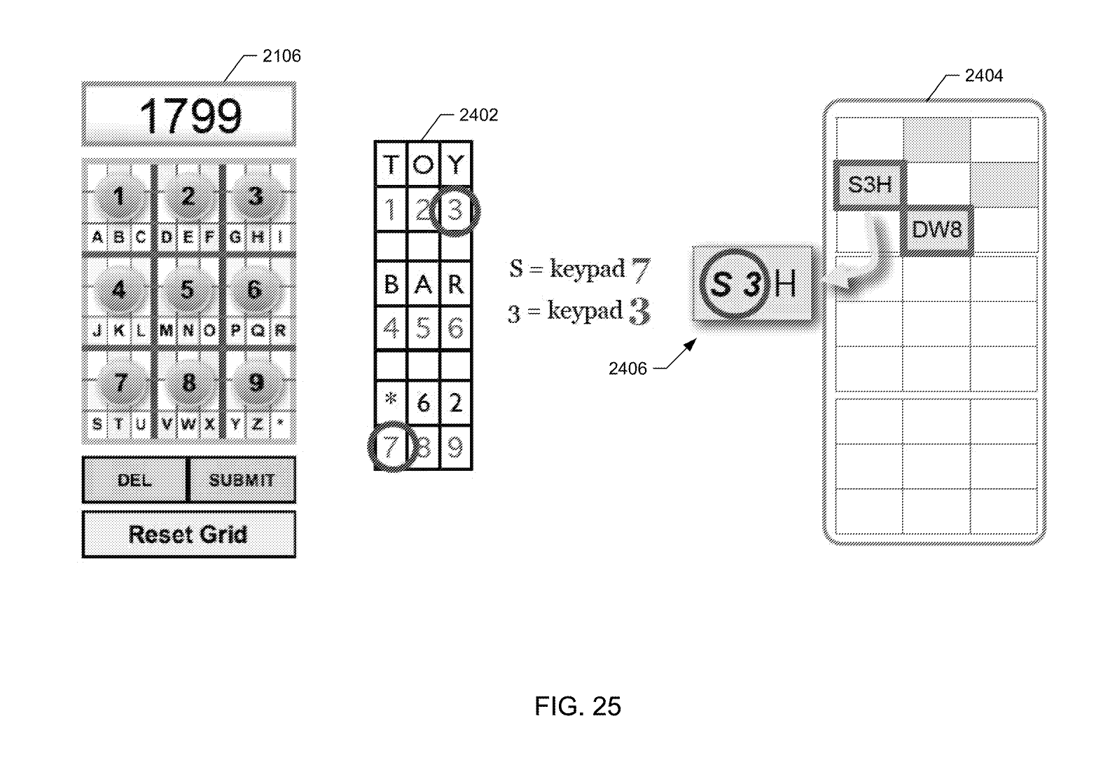

FIG. 25 shows the user progressing to the twelfth position after finding no other matches for positions five through eleven for the secret login rule 2302a. At this last position, the user notes the first two characters of the box (e.g., the characters ‘S’ and ‘3’). The user applies the third login rule 2406 to determine that the character ‘S’ corresponds to the keypad number 7 and the character ‘3’ corresponds to the keypad number 3. The user next applies the second login rule 2402 to determine that the number 7 corresponds to the character ‘*’ of the key phrase and that the number 3 corresponds to the character ‘Y’ of the key phrase. The user than determines that the character ‘*’ corresponds to the number 9 on the keypad 2106 and enters that number the third part of the answer. The user next determines that the character ‘Y’ corresponds to the number 9 on the keypad 2106 and enters that number as the fourth part of the answer. The user then transmits the answer, via the client device 502, to the processor or server hosting the account. Responsive to providing a correct answer, the client device 502 is provided assess to the account.

From this embodiment it should be appreciated that the use of multiple secret login rules that includes multiple steps provides further security from malicious applications. For example, from the point of view of a malicious application, a user is providing a random answer that cannot be easily predicted through reverse engineering or processing. For a malicious application to access the account, the application would have to determine each step for each secret login rule. However, with multiple steps and rules, there could be thousands, millions, billions, or trillions of possible combinations for a malicious application to process to determine the one combination assigned to the user. This amount of processing effectively acts as a deterrent for a malicious application from even attempting to determine the combination of steps and rules to access an account.

### Hardware Embodiment

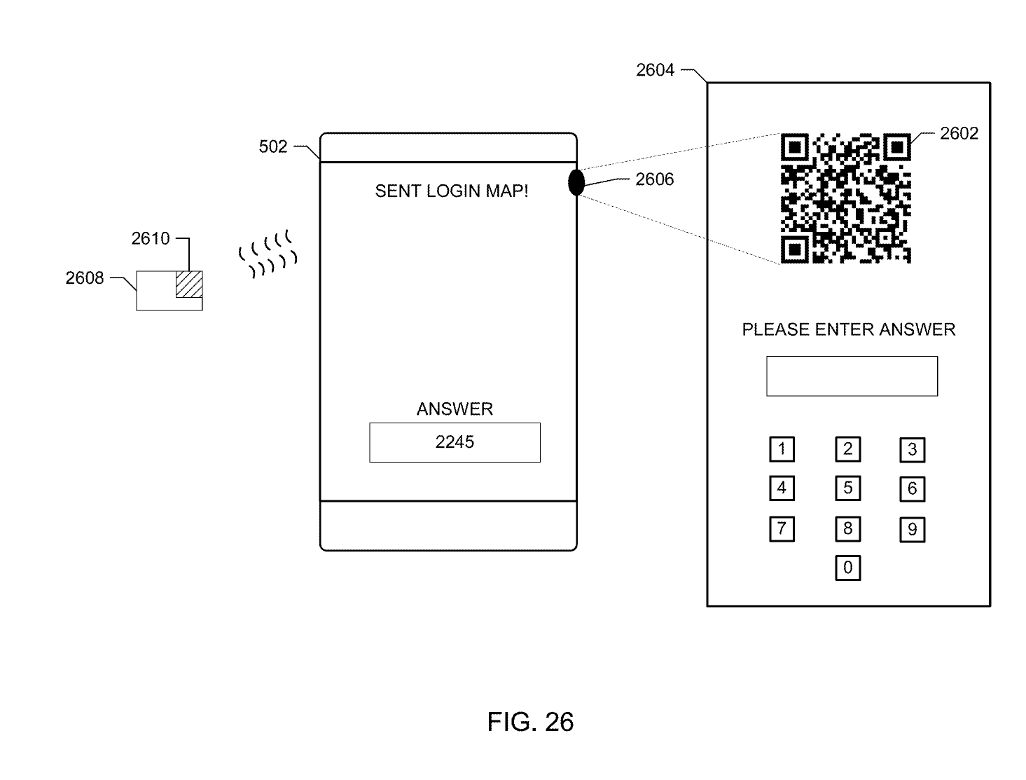

FIG. 26 shows a diagram of a hardware embodiment that uses electronically coded versions of login maps and secret login rules. In this embodiment, a login map 2602 is configured as a Quick Response (“QR”) code. The coded version of the login map 2602 can be a coded version of any one of the login maps described above. Alternatively, the login map 2602 can be relatively more complex because the processing to determine an answer is performed by a chip or processor, not by a user.

In this embodiment, the login map 2602 is displayed by a terminal 2604 such as, for example, a point of sale terminal, an ATM, etc. As discussed above, the login map 2602 may be generated specifically for a user (based on an identifier provided by the user) or may be generated for any user.

Alternatively, the login map 2602 may be displayed on the client device 502. For instance, an e-commerce application may provide the QR version of the login map 2602 as part of a checkout procedure or as part of a login authentication process. In these alternative embodiments, the QR code may be replaced with an electronic code, electronic puzzle, and/or electronic algorithm.

In the illustrated embodiment, a user of the client device 502 uses a camera 2606 to record an image of the login map 2602. Software on the client device 502 processes the image into a computer readable QR code. The client device 502 then transmits the QR code version of the login map 2602 to an integrated circuit (“IC”) card 2608, which includes one or more secret login rules 2610. The secret login rules 2610 are stored to a memory of the IC card 2608 and include one or more algorithms that include instructions specifying how information within a login map is to be processed to generate a correct answer. For example, the secret login rules 2610 may specify how a QR code is to be converted into a grid of characters, target positions on the grid, and one or more actions (e.g., calculations, comparisons, references to other information, movement to a location the grid, etc.) that are to be performed on characters at the target positions. In other words, the secret login rule 2610 is an electronically coded version of the secret login rules discussed above. In some embodiments, the secret login rule 2610 can be relatively more complex than the versions discussed above because the IC card 2608 is performing the processing instead of a user.

Returning to the example of FIG. 26, the IC card 2610 receives the transmission from the client device 502, processes the login map 2602 using the secret login rule 2610, and returns an answer based on the processing (e.g., ‘2245’). A user then provides the answer to the terminal 2604 to receive access to an account or to process a transaction. In other embodiments, the client device 2606 electrically transmits the answer to the terminal 2604.

It should be appreciated that the communication between the client device 502 and the IC card 2608 can include any wired or wireless communication method. For example, the IC card 2608 and the client device 502 may communicate using Near Field Communication (“NFC”). In this example, the IC card 2608 may not include a power source and instead relies on power provided by the client device 502 during communication of the login map 2604. In another example, the IC card 2608 may be connected to a data/communication interface of the client device 502 (e.g., an SD card slot, USB interface, etc.).

It should also be appreciated that the IC card 2608 may include more than one secret login rule. For example, the IC card 2608 may include separate secret login rules for different users, accounts, service providers, etc. In these instances, the client device 502 is configured to transmit an identifier of the user, an identifier of an account, and/or an identifier of a service provider. The IC card 2608 uses these identifiers to select the appropriate secret login rule.

The IC card 2608 may receive the secret login rule 2610 after a user has registered with a service provider. For example, after registering for an account, a service provider may transmit the secret login rule 2610 to the client device 502, which then writes the secret login rule 2610 to the IC card 2608. Alternatively, a service provider may store the secret login rule 2610 to the IC card 2608 after a user has registered for an account. The service provider then physically sends the IC card 2608 to the user.

It should be appreciated that the separation of the IC card 2608 from the client device 502 prevents the client device from knowing the secret login rule 2610. As a result, a malicious application on the client device 502 is not able to identify and/or modify the secret login rule 2610. At most, the malicious application is able to determine the login map 2602 and an answer.

However, in instances where the client device 502 already has a malicious application before the secret login rule 2610 is received, the malicious application is able to view and/or corrupt the secret login rule prior to transmission to the IC card 2608. To counter this scenario, the IC card 2608 may be configured during manufacture to include a first bit-String and identification number. The security processor 512 of FIG. 5 is separately sent a copy of the first bit-Sting and the identification number. During the first use of the IC card 2608, the client device 502 receives a second bit-Sting from the security processor 512, which operates in conjunction with a service provider associated with the IC card 2608. During subsequent uses, the IC card 2608 uses the first and second bit-Stings in conjunction with the secret login rule 2610 to determine an answer based on login maps 2602. Similarly, the security processor 512 uses the first and second bit-Stings in conjunction with the secret login rule 2610 to determine the correct answer. Thus, both the IC card 2608 and the security processor 512 separately possess the same bit-Stings used to determine an answer. However, a malicious application on the client device 502 does not have access to the first bit-Sting because it was separately stored (e.g., not transmitted through the client device 502) to the IC card 2608 and the security processor 512.

In an alternative embodiment to FIG. 26, the IC card 2608 may communicate directly with the terminal 2604 without the use of a client device. The IC card 2608 may be a credit card that includes a LCD display and NFC connectivity. A user places the IC card 2608 in proximity to a point of sale terminal 2604, causing the IC card 2608 to receive the login map 2602. As discussed above, the IC card 2608 uses the secret login rule 2610 to determine an answer to the login map 2602. The IC card 2608 then displays the answer via the LCD. A user next enters the answer as part of a pin or authentication number at the point of sale terminal 2604. Alternatively, in instances where the IC card 2608 does not include an LCD display, the IC card 2608 transmits the answer to the terminal 2606 via NFC.

### Conclusion

It will be appreciated that all of the disclosed methods and procedures described herein can be implemented using one or more computer programs or components. These components may be provided as a series of computer instructions on any conventional computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method comprising:
receiving a request from a user to access an account, the request including an identifier associated with the user;
determining a secret login rule previously provided to the user based on the identifier;
transmitting observable information to be displayed in a login map by a client device associated with the user;
determining a correct answer by analyzing the positioning of the displayed observable information within the login map in conjunction with the secret login rule associated with the user;
receiving an answer from the client device; and
providing the user access to the account responsive to the answer matching the correct answer.

2. The method of claim 1, wherein the secret login rule specifies how the observable information in a login map is to be observed by the user to receive access to an account.

3. The method of claim 1, further comprising prior to transmitting the observable information, generating the observable information using the secret login rule in conjunction with a random character generator.

4. The method of claim 1, wherein the observable information in conjunction with the login map includes a graphical representation of at least one of characters, letters, numbers, and symbols arranged in a pattern.

5. The method of claim 1, further comprising:
receiving a second request from a second user to access a second account, the second request including a second identifier associated with the second user and the second account hosted by a same entity as the first account;
determining a second secret login rule previously provided to the second user, the second secret login rule being different from the secret login rule provided to the user;
transmitting a second observable information to be displayed in the login map by a second client device associated with the second user, the second observable information being different from the observable information;
determining a second correct answer by comparing the positioning of the displayed second observable information within the login map in conjunction with the second secret login rule; and
responsive to determining that a second answer received from the second client device matches the second correct answer, providing the second user access to the second account.

6. The method of claim 1, further comprising:
responsive to determining that the answer received from the client device does not match the correct answer, transmitting second observable information to be displayed in the login map;
determining a second correct answer by comparing the positioning of the displayed second observable information within the login map in conjunction with the secret login rule;
receiving a second answer from the client device; and
providing the user access to the account responsive to the second answer matching the second correct answer.

7. The method of claim 1, further comprising transmitting the observable information in conjunction with the login map to the client device.

8. The method of claim 1, further comprising:
determining a second secret login rule previously provided to the user based on the identifier; and
determining the correct answer by analyzing the positioning of the displayed observable information within the login map in conjunction with the secret login rule and the second secret login rule,
wherein information generated from the secret login rule is to be applied to the second secret login rule.

9. A machine-accessible device having instructions stored thereon that, when executed, cause a machine to at least:
receive a request from a user to create an account;
receive a selection of a level of security from the user;
determine a secret login rule for the user based on the selected level of security, the secret login rule corresponding to a type of login map used to provide access to the account; and
transmit the secret login rule to the user.

10. The machine-accessible device of claim 9, further comprising instructions stored thereon that are configured when executed to cause the machine to responsive to prompting the user, receiving at least one of a user name and password for the account.

11. The machine-accessible device of claim 9, wherein the secret login rule is transmitted to use via at least one of an e-mail, a text message, or a physical document.

12. The machine-accessible device of claim 9, further comprising instructions stored thereon that are configured when executed to cause the machine to:
select a first type of login map responsive to the user selecting a nominal level of security; and
select a second type of login map different from the first type of login map responsive to the user selecting a relatively greater level of security,
wherein a first secret login rule corresponding to the first type of login map includes fewer steps the user is to perform to determine an answer compared to a second secret login rule corresponding to the second type of login map.

13. The machine-accessible device of claim 9, wherein
the first type of login map includes a grid of characters,
the first secret login rule includes at least one secret square within the grid,
the second type of login map includes a key, a first rotary wheel, and a second rotary wheel, and
the second secret login rule includes a starting position of an inner ring of the first rotary wheel, a first step to determine an ending position in an outer ring of the first rotary wheel based on the key, and a second step to determine an answer based on a comparison of the ending position with the starting position.

14. The machine-accessible device of claim 9, further comprising instructions stored thereon that are configured when executed to cause the machine to determine for the secret login rule at least one action the user is to perform based at least in part on the type of login map.

15. The machine-accessible device of claim 14, wherein the action includes at least one of a calculation, a comparison, a reference to other information, and a movement to a location on a login map.

16. A system comprising:
a server configured to:
host a service for authorized users; and
receive a request from a client device associated with a user to access an account for the service, the request including an identifier associated with the user;
a security processor communicatively coupled to the server and configured to:
determine a secret login rule previously provided to the user based on the identifier;
determine a login map associated with the account of the user;
generate observable information based at least in part on the secret login rule and the login map;
transmit the observable information and the login map to the client device;
determine a correct answer by analyzing the positioning of the observable information within the login map in conjunction with the secret login rule; and
responsive to determining that a answer received from the client device matches the correct answer, instructing the server to provide the client device access to the account for the service.

17. The system of claim 16, wherein the observable information and the login map are transmitted from the server to the client device and the server receives the answer from the client device.

18. The system of claim 16, wherein the security processor is integrated with the server.

19. The system of claim 16, wherein the security processor is remotely located from the server in a cloud computing environment.

20. The system of claim 16, wherein the client device is configured to:
transmit the observable information to a card that includes the secret login rule; and
receive the answer from the card.
